(19) United States
(12) Patent Application Publication
(10) Pub. No.: US 2025/0324230 A1
(43) Pub. Date: Oct. 16, 2025

(54) PROVIDING ROAMING ASSISTANCE TO WIRELESS DEVICES

(71) Applicant: Cisco Technology, Inc., San Jose, CA (US)

(72) Inventors: Jerome Henry, Pittsboro, NC (US); Matthew S. MacPherson, Morrisville, NC (US); Sudhir Kumar Jain, Hayward, CA (US)

(21) Appl. No.: 19/173,673

(22) Filed: Apr. 8, 2025

Related U.S. Application Data
(60) Provisional application No. 63/634,848, filed on Apr. 16, 2024.

(51) Int. Cl. H04W 8/08; H04B 17/318; H04W 48/16; H04W 64/00; H04W 76/10

(52) U.S. Cl. CPC H04W 8/08; H04B 17/318; H04W 48/16; H04W 64/006; H04W 76/10

(57) ABSTRACT

Devices, networks, systems, methods, and processes for providing roaming assistance to wireless devices are provided herein. To provide roaming assistance to a wireless device, a network device may establish a communication link with the wireless device. The network device may then obtain at least one of motion data or location data of the wireless device. The network device may obtain the motion data or the location data based on at least one of a set of movement characteristics of the wireless device, a set of location characteristics of the wireless device, or one or more RF parameters of the wireless device relative to at least one neighboring network device. The network device may then generate a list of one or more neighboring network devices based on the obtained motion data or the location data, and transmit the list of one or more neighboring network devices to the wireless device.

### CROSS-REFERENCE

This application claims the benefit of priority to U.S. Provisional Patent Application No. 63/634,848, filed Apr. 16, 2024, the entirety of which is incorporated herein by reference.

### FIELD

The present disclosure relates to wireless networks. More particularly, the present disclosure relates to providing roaming assistance to wireless devices.

### BACKGROUND

Wi-Fi, or wireless fidelity, has become a fundamental technology in today's world, enabling wireless connectivity across a broad spectrum of devices. The significance of Wi-Fi stems from the convenience and flexibility it offers, allowing for seamless Internet access and facilitating communication, data transfer, and various online activities. As a cornerstone of connectivity in homes, businesses, public spaces, and educational institutions, Wi-Fi assists in enhancing productivity and connectivity for individuals and organizations alike.

As technology has advanced, the role of Wi-Fi has evolved to meet growing demands for faster speeds, greater bandwidth, and improved security. These increasing demands have driven the continuous development of more advanced Wi-Fi standards. As these technologies progress, there is an increasing interest to update Wi-Fi standards and protocols for delivering enhanced performance, greater capacity, and improved efficiency. One such update pertains to Wi-Fi roaming, where users expect their devices to maintain a stable connection to a Wi-Fi network as they move between different areas. The Wi-Fi network may involve one or more network devices that enable Wi-Fi-compatible devices to stay connected to the Internet or communicate with other devices within the network.

Various roaming assistance methods have been developed to enable seamless roaming across Wi-Fi networks. These methods involve a network device recommending a neighboring network device for Wi-Fi roaming. For example, when a wireless device approaches an edge of a coverage area, the network device may suggest a neighboring network device to which the wireless device can roam. However, these roaming assistance methods may not always be reliable. For example, the wireless device may be moving away from the recommended neighboring network device, making the recommended neighboring network device an unsuitable choice for roaming. Thus, roaming assistance continues to face challenges in adapting to dynamic movements of mobile users.

### SUMMARY OF THE DISCLOSURE

Systems and methods for providing roaming assistance to wireless devices in accordance with embodiments of the disclosure are described herein. In many embodiments, a network device may include one or more processors and a memory. The memory may be coupled to the one or more processors and may include a roaming management logic. The roaming management logic may be configured to establish a communication link with a wireless device, obtain at least one of motion data or location data of the wireless device, generate a list of one or more neighboring network devices based on the obtained at least one of the motion data or the location data of the wireless device, and transmit, for roaming assistance, the list of one or more neighboring network devices to the wireless device.

In a number of embodiments, the roaming management logic may further be configured to receive a roaming assistance request from the wireless device, including an indication of at least one of a set of movement characteristics or a set of location characteristics of the wireless device, and obtain at least one of the motion data or the location data of the wireless device based on the indication of at least one of the set of movement characteristics or the set of location characteristics of the wireless device.

In a variety of embodiments, the roaming assistance request may be received in at least one of an action frame or a wireless frame.

In further embodiments, the wireless frame may be one of an Advanced Service Request (ASR) or a Service Classification Signal (SCS).

In still further embodiments, the roaming assistance request may be configured to indicate at least one traffic type that the wireless device is to transmit.

In more embodiments, the indication may include a flag indicative of one of a moving state or a stationary state of the wireless device.

In still more embodiments, the indication may include a geographical location of the wireless device.

In additional embodiments, the indication includes a distance between the network device and the wireless device.

In still additional embodiments, the indication comprises a set of values representing one of a location of the wireless device or a movement of the wireless device.

In numerous embodiments, at least one value in the set of values represents one of an acceleration of the wireless device, a direction of the wireless device, or a speed of the wireless device.

In several embodiments, a value in the set of values represents a vector including one or more of an acceleration of the wireless device, a direction of the wireless device, or a speed of the wireless device.

In numerous additional embodiments, the roaming management logic may further be configured to obtain at least one of the motion data or the location data of the wireless device based on one or more radio frequency parameters of the wireless device relative to at least one neighboring network device.

In further more embodiments, the one or more radio frequency parameters comprise a Received Signal Strength Indicator (RSSI).

In yet more embodiments, the roaming management logic may further be configured to transmit the list of one or more neighboring network devices to the wireless device in one of a basic service set (BSS) transition management (BTM) message or a neighbor report.

In still yet more embodiments, the roaming management logic may further be configured to transmit the list of one or more neighboring network devices to the wireless device unsolicited.

In many further embodiments, the roaming management logic may further be configured to transmit, to the wireless device, a roaming probability indication for at least one neighboring network device in the list of one or more neighboring network devices.

In still yet further embodiments, the roaming management logic may further be configured to transmit, to the wireless device, a signal strength indicator corresponding to a mid-point between the network device and a neighboring network device in the list of one or more neighboring network devices.

In yet several embodiments, the roaming management logic may further be configured to receive, from the wireless device, feedback on the roaming assistance in response to the transmission of the list of one or more neighboring network devices.

In several additional embodiments, a network device may include one or more processors and a memory. The memory may be coupled to the one or more processors and may include a roaming management logic. The roaming management logic may be configured to establish a communication link with a network device and receive, for roaming assistance, a list of one or more neighboring network devices. The list of one or more neighboring network devices may be based on at least one of motion data or location data of the wireless device. The roaming management logic may further be configured to perform a scan for at least one neighboring network device in the list of one or more neighboring network devices.

In one or more embodiments, a method for managing roaming in a wireless network is described. The method may establish a communication link with a wireless device, obtaining at least one of motion data or location data of the wireless device, generating a list of one or more neighboring network devices based on the obtained at least one of the motion data or the location data of the wireless device, and transmitting, for roaming assistance, the list of one or more neighboring network devices to the wireless device.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a wireless local networking system in accordance with various embodiments of the disclosure;

FIG. 2 is a conceptual depiction of a communication layer architecture in accordance with various embodiments of the disclosure;

FIG. 3 is a conceptual network diagram of various environments in which a roaming management logic can operate on a plurality of network devices in accordance with various embodiments of the disclosure;

FIG. 4 is a conceptual network diagram for providing roaming assistance to a wireless device in accordance with various embodiments of the disclosure;

FIG. 5 is a diagram of a list of a plurality of neighboring network devices in accordance with various embodiments of the disclosure;

FIG. 6 is a flowchart depicting a process for generating the list of one or more neighboring network devices in accordance with various embodiments of the disclosure;

FIG. 7 is a flowchart depicting a process for transmitting the list of one or more neighboring network devices to the wireless device in accordance with various embodiments of the disclosure;

FIG. 8 is a flowchart depicting a process for receiving a feedback on roaming assistance from the wireless device in accordance with various embodiments of the disclosure;

FIG. 9 is a flowchart depicting a process for obtaining at least one of motion data or location data of the wireless device in accordance with various embodiments of the disclosure;

FIG. 10 is a flowchart depicting a process for establishing a communication link with at least one neighboring network device in accordance with various embodiments of the disclosure;

FIG. 11 is a flowchart depicting a process for transmitting a feedback to a network device in accordance with various embodiments of the disclosure; and

FIG. 12 is a conceptual block diagram of a device suitable for configuration with the roaming management logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein for providing roaming assistance to wireless devices. As used herein, a network device (for example, an access point) may enable a wireless device (for example, a station) to connect to a network (such as the Internet) or other wireless devices using Wi-Fi, Bluetooth, or a similar technology. The network device may include Wi-Fi routers and Wi-Fi Extenders. Furthermore, the wireless device may include a mobile computing device, such as a smartphone, tablet, laptop, notebook, wearable device, or the like. As used herein, Wi-Fi roaming may refer to a process where the wireless device may switch a Wi-Fi connection from a first network device to a second network device as the wireless device roams from a physical area serviced by the first network device to a physical area serviced by the second network device. The second network device may interchangeably be referred to as the neighboring network device.

Various methods have been developed to enable seamless roaming across Wi-Fi networks. These methods may involve a network device recommending an optimal neighboring network device for Wi-Fi roaming. For example, when a wireless device approaches the edge of a coverage area (for example, a cell or a Basic Service Area “BSA”) serviced by the network device, the network device may suggest a neighboring network device to which the wireless device can roam. However, this approach may not always be reliable. For example, the wireless device may be moving away from the recommended neighboring network device, making the recommended neighboring network device an unsuitable choice for roaming. As a result, Wi-Fi roaming continues to face challenges in meeting user expectations for seamless and uninterrupted connectivity.

In addition to the above-mentioned challenges, another issue faced by the wireless device is that the wireless device may need to reach the edge of the cell serviced by the network device before detecting the next optimal network device, which can result in delays and interrupt seamless connectivity. Current mechanisms, such as the wireless device independently scanning for the next optimal network device or requesting information from the network device about the next optimal network device, provide some assistance but are also constrained by inherent limitations. For example, the wireless device may send a Basic Service Set (BSS) Transition Management (BTM) query, as defined in the 802.11v standard, or a neighbor report request, as specified in the 802.11k standard. In the case of the BTM query, the wireless device may request information about the next optimal network device from the network device to which the wireless device is currently connected. However, the response time can be significant, for example, sometimes up to 400 milliseconds, leading to delays and interruptions in connectivity. Similarly, the neighbor report request may enable the wireless device to query the network device for a list of neighboring network devices before reaching the edge of the cell. However, the list provided by the network device may be unsorted (or unordered) and lack prioritization. Consequently, the wireless device may be unable to obtain information to make an optimal decision, preventing the wireless device from efficiently selecting the most optimal neighboring network device for connection. This absence of prioritization can further complicate the roaming process, resulting in suboptimal handoffs and ultimately interrupting the seamless and continuous network experience that users expect from Wi-Fi networks.

Therefore, the present disclosure provides a technical solution for enhancing roaming assistance for wireless devices. Specifically, the present disclosure describes a network device capable of obtaining location data and/or motion data of a wireless device (for example, that requires zero-scan roaming assistance). By obtaining the location data and/or motion data, the network device may provide customized recommendations, enabling the wireless device to efficiently connect to the most optimal neighboring network device. In various embodiments, the network device may include one or more processors and a memory that stores a roaming management logic. The roaming management logic may be configured to obtain the location data and/or the motion data of the wireless device and generate a list of one or more neighboring network devices, which is sorted and/or prioritized based on factors such as signal strength, roaming probability, and/or additional performance metrics. The sorted list of the one or more neighboring network devices may enable the wireless device to identify the next optimal neighboring network device for Wi-Fi roaming, thereby minimizing the need for extensive scanning. The present disclosure may enhance the roaming experience by facilitating seamless transitions between the wireless device and the next optimal neighboring network device while reducing the need for additional scanning.

In many embodiments, the network device may establish communication with the wireless device to obtain motion data and/or location data from the wireless device. The network device may generate a list of one or more neighboring network devices based on the motion data and/or the location data of the wireless device. The network device may transmit the list of one or more neighboring network devices to the wireless device to assist with the Wi-Fi roaming process.

In numerous embodiments, the network device may handle a roaming assistance request from the wireless device, which may include movement and/or location characteristics. The wireless device may transmit the roaming assistance request via an action frame or a wireless frame, such as an Advanced Service Request (ASR) or a Service Classification Signal (SCS), which may include specific data about the movement and/or location characteristics of the wireless device. For example, the network device may receive various parameters related to the state of the wireless device, such as acceleration, direction, or speed. In further embodiments, the network device may receive Radio Frequency (RF) parameters, such as Received Signal Strength Indicator (RSSI), of the wireless device relative to at least one neighboring network device. The network device may obtain the motion data and/or the location data of the wireless device by analyzing the movement and/or location characteristics of the wireless device, such as the acceleration, direction, or speed of the wireless device, and/or the RF parameters of the wireless device relative to the at least one neighboring network device. In yet various embodiments, the wireless device may receive feedback from the wireless device regarding the roaming assistance provided.

The integration of the motion data and/or the location data into roaming assistance may offer various advantages in optimizing the roaming process for the wireless device. By leveraging motion data, such as acceleration, direction, and speed, the network device can track the wireless device's movement and predict a position of the wireless device, enabling proactive roaming assistance. Further, analyzing RF parameters, such as the RSSI, may allow the network device to evaluate the signal strength between the wireless device and neighboring network devices, thereby improving the accuracy of the decision-making process. This may allow the network device to prioritize the most suitable neighboring network device based on the wireless device's movement, trajectory, or signal quality, thereby minimizing the need for additional scans. As a result, the wireless device can experience faster handoffs, improved roaming efficiency, and more reliable, uninterrupted network connectivity. These improvements can lead to a better user experience by reducing delays and ensuring a seamless transition between network devices.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in-one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

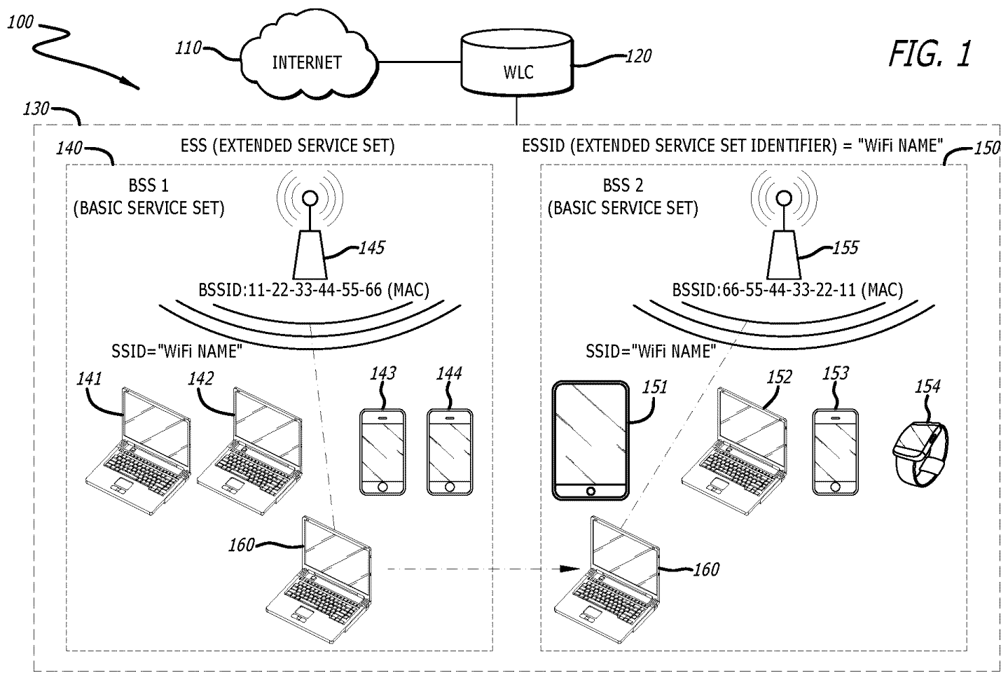

Referring to FIG. 1, a schematic block diagram of a wireless local networking system 100 in accordance with various embodiments of the disclosure is shown. Wireless local networking standards assist in enabling seamless communication and connectivity between various devices within localized areas. One of the most prevalent standards is Wi-Fi, is based on the IEEE 802.11 family of protocols. Wi-Fi provides high-speed wireless access to the internet and local network resources, with iterations such as 802.11a, 802.11b, 802.11g, 802.11n, 802.11ac, and 802.11ax, each offering improvements in speed, range, and efficiency. Each adoption of Wi-Fi standards is often designed to bring enhanced performance, increased capacity, and better efficiency in crowded network environments. Other standards can commonly be used for short-range wireless communication between devices, particularly in the realm of Personal Area Networks (PANs). Both Wi-Fi and other protocols have become integral components of modern connectivity, supporting a wide range of devices and applications across homes, businesses, and public spaces. Emerging technologies and future iterations continue to refine wireless networking standards, ensuring the evolution of efficient, reliable, and secure wireless communication.

In the realm of IEEE 802.11 wireless local area networking standards, commonly associated with Wi-Fi technology, a service set plays a pivotal role in defining and organizing wireless network devices. A service set essentially refers to a collection of wireless devices that share a common Service Set Identifier (SSID). The SSID, often recognizable to users as the network name presented in natural language, serves as a means of identification and differentiation among various wireless networks. Within a service set, the nodes-comprising devices like laptops, smartphones, or other Wi-Fi-enabled devices-operate collaboratively, adhering to shared link-layer networking parameters. These parameters encompass specific communication settings and protocols that facilitate seamless interaction among the devices within the service set. Essentially, a service set forms a cohesive and logical network segment, creating an organized structure for wireless communication where devices can communicate and share data within the defined parameters, enhancing the efficiency and coordination of wireless networking operations.

In the context of wireless local area networking standards, a service can be configured in two distinct forms: a Basic Service Set (BSS) or an Extended Service Set (ESS). A basic service set represents a subset within a service set, comprised of devices that share common physical-layer medium access characteristics. These characteristics include parameters such as radio frequency, modulation scheme, and security settings, ensuring seamless wireless networking among the devices. The basic service set is uniquely identified by a Basic Service Set Identifier (BSSID), a 48-bit label adhering to MAC-48 conventions. Despite the possibility of a device having multiple BSSIDs, each BSSID is typically associated with, at most, one basic service set at any given time.

A basic service set should not be confused with the coverage area of an access point, which is referred to as the Basic Service Area (BSA). The BSA encompasses the physical space within which an access point provides wireless coverage, while the basic service set focuses on the logical grouping of devices sharing common networking characteristics. This distinction emphasizes that the basic service set is a conceptual grouping based on shared communication parameters, while the BSA defines the spatial extent of an access point's wireless reach. Understanding these distinctions is fundamental for effectively configuring and managing wireless networks, ensuring optimal performance and coordination among connected devices.

The Service Set Identifier (SSID) defines a service set or extends service set. Normally it is broadcast in the clear by stations in beacon packets to announce the presence of a network and seen by users as a wireless network name. Unlike basic service set identifiers, SSIDs are usually customizable. Since the contents of an SSID field are arbitrary, the 802.11 standard permits devices to advertise the presence of a wireless network with beacon packets. A station may also likewise transmit packets in which the SSID field is set to null; this prompts an associated access point to send the station a list of supported SSIDs. Once a device has associated with a basic service set, for efficiency, the SSID is not sent within packet headers; only BSSIDs are used for addressing.

An Extended Service Set (ESS) is a more sophisticated wireless network architecture designed to provide seamless coverage across a larger area, typically spanning environments such as homes or offices that may be too expansive for reliable coverage by a single access point. This network is created through the collaboration of multiple access points, presenting itself to users as a unified and continuous network experience. The extended service set operates by integrating one or more infrastructure Basic Service Sets (BSS) within a common logical network segment, characterized by sharing the same IP subnet and Virtual Local Area Network (VLAN).

The concept of an extended service set is particularly advantageous in scenarios where a single access point cannot adequately cover the entire desired area. By employing multiple access points strategically, users can move seamlessly across the extended service set without experiencing disruptions in connectivity. This is crucial for maintaining a consistent wireless experience in larger spaces, where users may transition between different physical locations covered by distinct access points.

Moreover, extended service sets offer additional functionalities, such as distribution services and centralized authentication. The distribution services facilitate the efficient distribution of network resources and services across the entire extended service set. Centralized authentication enhances security and simplifies access control by allowing users to authenticate once for access to any part of the extended service set, streamlining the user experience and network management. Overall, extended service sets provide a scalable and robust solution for ensuring reliable and comprehensive wireless connectivity in diverse and expansive environments.

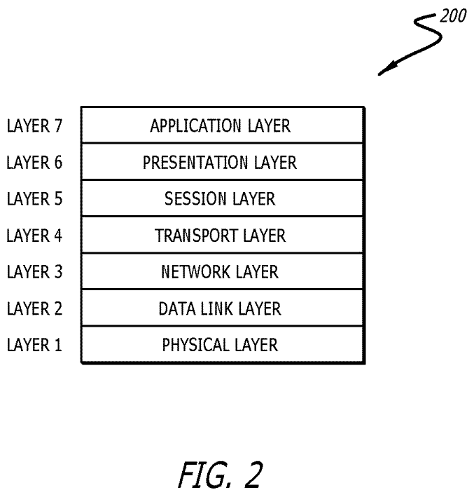

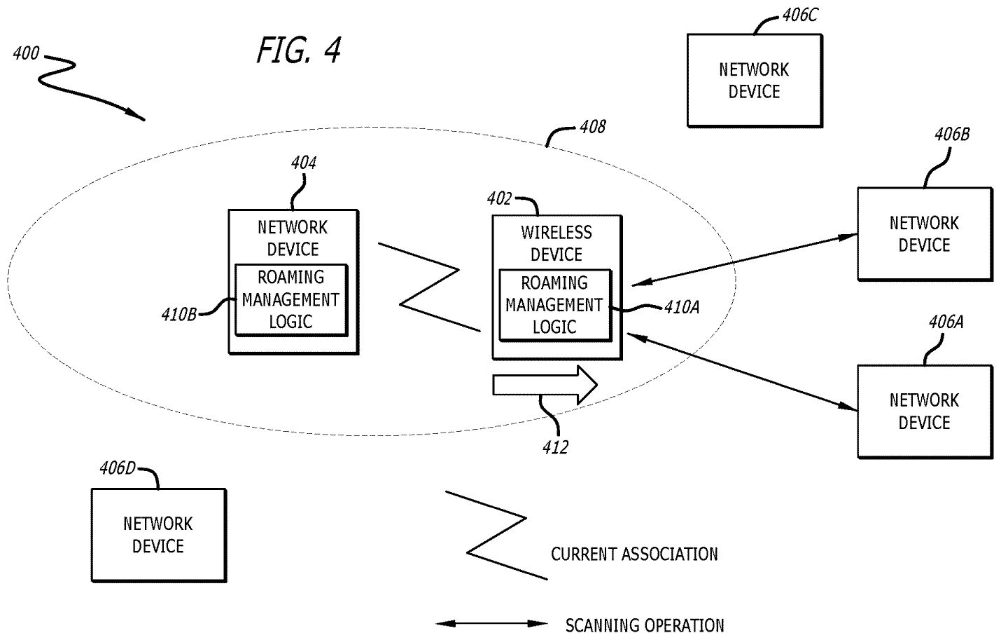

The network can include a variety of user end devices that connect to the network. These devices can sometimes be referred to as wireless devices or client devices or stations (i.e., “STAs”). Each device is typically configured with a Medium Access Control (“MAC”) address in accordance with the IEEE 802.11 standard. As described in more detail in FIG. 2, a physical layer can also be configured to communicate over the wireless medium. As described in more detail in FIG. 4, various devices on a network can include components such as a processor, memory, transceiver, user interface, etc. These components can be configured to process frames of data transmitted and/or received over the wireless network. Access points (“APs”) are network devices configured to provide access to user end devices to a larger network, such as the Internet 110.

In the embodiment depicted in FIG. 1, a wireless network controller 120 (shown as WLC) is connected to a public network such as the Internet 110. The wireless network controller 120 is in communication with an Extended Service Set (ESS) 130. The ESS 130 comprises two separate basic service sets (a first BSS 140 denoted as “BSS 1” and a second BSS 150 denoted as “BSS 2”). The ESS 130, the first BSS 140, and the second BSS 150 all broadcast and are configured with the same SSID “WiFi Name”, which can be a BSSID for each of the first BSS 140 and the second BSS 150 as well as an ESSID for the ESS 130.

Within the first BSS 140, the network comprises a first notebook 141, a second notebook 142, a first phone 143, a second phone 144, a first access point 145, and a third notebook 160. One or more devices among the first notebook 141, the second notebook 142, the third notebook 160, the first phone 143, and the second phone 144 may communicate with the first access point 145. Likewise, in the second BSS 150, the network comprises a tablet 151, a fourth notebook 152, a third phone 153, a watch 154, and a second access point 155. One or more devices among the tablet 151, the fourth notebook 152, the third phone 153, and the watch 154 may communicate with the second access point 155. Further, the third notebook 160 may be a part of the first BSS 140 or the second BSS 150 by being communicatively coupled to the first access point 145 or the second access point 155, respectively. In this setup, the third notebook 160 can be seen to “roam” from the physical area serviced by the first BSS 140 to the physical area serviced by the second BSS 150.

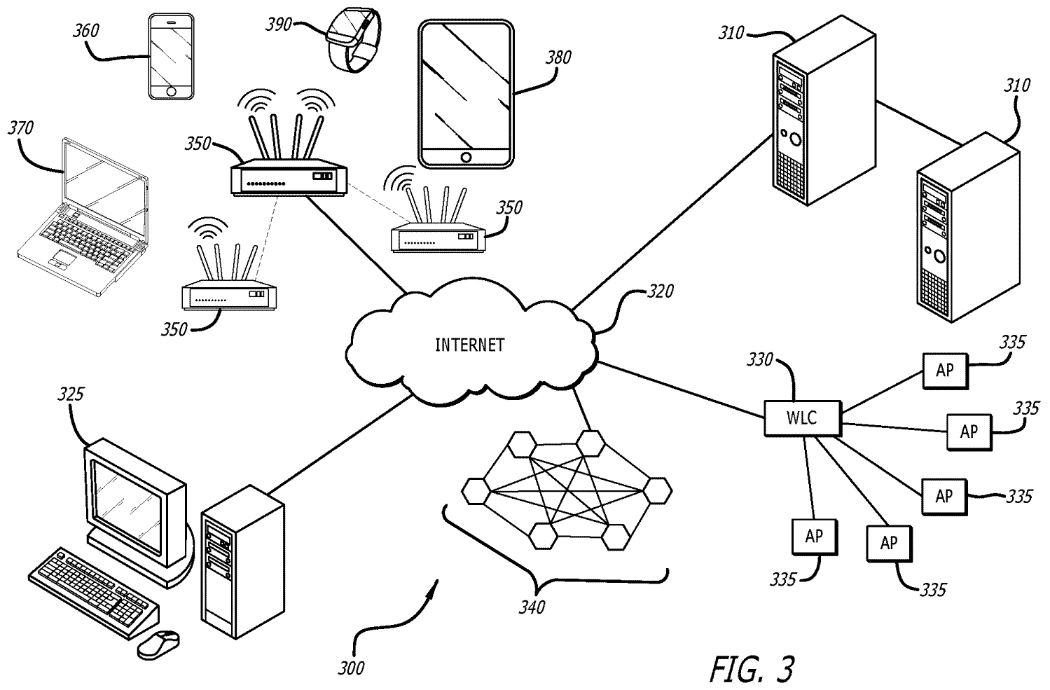

For the purpose of illustration, the ESS 130 having only two BSSs (e.g., the first BSS 140 and the second BSS 150) is shown in FIG. 1. However, the ESS 130 may include a plurality of BSSs. Various embodiments are based on a realization that the third notebook 160 may face challenges in selecting the next optimal access point while the third notebook 160 attempts to move out of the physical area serviced by a currently associated BSS. To this end, a roaming management logic is disclosed herein. In various embodiments, the roaming management logic may enable the third notebook 160 to select and connect to the next optimal access point. As used herein, the next optimal access point may be an access point that ensures the third notebook 160 maintains a stable connection with the network while the third notebook 160 attempts to move out of the physical area serviced by the currently associated BSS. The roaming management logic for selecting and connecting to the next optimal access point is explained in detail in conjunction with FIGS. 3-12.

Although a specific embodiment for the wireless local networking system 100 is described above with respect to FIG. 1, any of a variety of systems and/or processes may be utilized in accordance with embodiments of the disclosure. For example, the wireless local networking system 100 may be configured into any number of various network topologies including different types of interconnected devices and user devices. The elements depicted in FIG. 1 may also be interchangeable with other elements of FIGS. 2-12 as required to realize a particularly desired embodiment.

Referring to FIG. 2, a conceptual depiction of a communication layer architecture 200 in accordance with various embodiments of the disclosure is shown. In many embodiments, the communication layer architecture 200 may be utilized to carry out various communications described or required herein. In still more embodiments, the communication layer architecture 200 may be configured as the open systems interconnection model, more commonly known as the OSI model. Likewise, the communication layer architecture 200 may have seven layers which may be implemented in accordance the OSI model.

In the embodiment depicted in FIG. 2, the communication layer architecture 200 includes a physical layer as a first layer (denoted as “Layer 1” in FIG. 2). The physical layer may serve as the foundational layer among the seven layers. The physical layer is responsible for the transmission and reception of raw, unstructured data bits over a physical medium, such as cables or wireless connections. At this layer, the focus is on the electrical, mechanical, and procedural characteristics of the hardware, including cables, connectors, and signaling. The primary goal is to establish a reliable and efficient means of physically transmitting data between devices. The physical layer does not concern itself with the meaning or interpretation of the data; instead, it concentrates on the fundamental aspects of transmitting binary information, addressing issues like voltage levels, data rates, and modulation techniques. Devices operating at the physical layer include network cables, connectors, repeaters, and hubs. The physical layer's successful operation is fundamental to the functioning of the entire OSI model, as it forms the bedrock upon which higher layers build their more complex communication protocols and structures.

In some embodiments, the communication layer architecture 200 may include a data link layer as a second layer (donated as “Layer 2” in FIG. 2). The data link layer may be configured to be primarily concerned with the reliable and efficient transmission of data between directly connected devices over a particular physical medium. Its responsibilities include framing data into frames, addressing, error detection, and, in some cases, error correction. The data link layer is divided into two sublayers: Logical Link Control (LLC) and Media Access Control (MAC). The LLC sublayer manages flow control and error checking, while the MAC sublayer is responsible for addressing devices on the network and controlling access to the physical medium. Ethernet is a common example of a data link layer protocol. This layer ensures that data is transmitted without errors and manages the flow of frames between devices on the same local network. Bridges and switches operate at the data link layer, making forwarding decisions based on MAC addresses. Overall, the data link layer plays a crucial role in creating a reliable point-to-point or point-to-multipoint link for data transmission between neighboring network devices.

In various embodiments, the communication layer architecture 200 may include a network layer as a third layer (denoted as “Layer 3” in FIG. 2). The network layer may be configured as a pivotal component responsible for the establishment of end-to-end communication across interconnected networks. Its primary functions include logical addressing, routing, and the fragmentation and reassembly of data packets. The network layer ensures that data is efficiently directed from the source to the destination, even when the devices are not directly connected. Internet Protocol (IP) is a prominent example of a network layer protocol. Devices known as routers operate at this layer, making decisions on the optimal path for data to traverse through a network based on logical addressing. The network layer abstracts the underlying physical and data link layers, allowing for a more scalable and flexible communication infrastructure. In essence, it provides the necessary mechanisms for devices in different network segments to communicate, contributing to the end-to-end connectivity that is fundamental to the functioning of the internet and other large-scale networks.

In additional embodiments, the communication layer architecture 200 may include a transport layer as a fourth layer (denoted as “Layer 4” in FIG. 2). The transport layer may be a critical element responsible for the end-to-end communication and reliable delivery of data between devices. Its primary objectives include error detection and correction, flow control, and segmentation and reassembly of data. Two key transport layer protocols are Transmission Control Protocol (TCP) and User Datagram Protocol (UDP). TCP ensures reliable and connection-oriented communication by establishing and maintaining a connection between sender and receiver, and it guarantees the orderly and error-free delivery of data through mechanisms like acknowledgment and retransmission. UDP, on the other hand, offers a connectionless and more lightweight approach suitable for applications where speed and real-time communication take precedence over reliability. The transport layer shields the upper-layer protocols from the complexities of the network and data link layers, providing a standardized interface for applications to send and receive data, making it a crucial facilitator for efficient, end-to-end communication in networked environments.

In further embodiments, the communication layer architecture 200 may include a session layer as a fifth layer (denoted as “Layer 5” in FIG. 2). The session layer may be configured to play a pivotal role in managing and controlling communication sessions between applications. It provides mechanisms for establishing, maintaining, and terminating dialogues or connections between devices. The session layer helps synchronize data exchange, ensuring that information is sent and received in an orderly fashion. Additionally, it supports functions such as checkpointing, which allows for the recovery of data in the event of a connection failure, and dialog control, which manages the flow of information between applications. While the session layer is not as explicitly implemented as lower layers, its services are crucial for maintaining the integrity and coherence of data during interactions between applications. By managing the flow of data and establishing the context for communication sessions, the session layer contributes to the overall reliability and efficiency of data exchange in networked environments.

In still further embodiments, the communication layer architecture 200 may include a presentation layer as a sixth layer (denoted as “Layer 6” in FIG. 2). The presentation layer may focus on the representation and translation of data between the application layer and the lower layers of the network stack. It can deal with issues related to data format conversion, ensuring that information is presented in a standardized and understandable manner for both the sender and the receiver. The presentation layer is often responsible for tasks such as data encryption and compression, which enhance the security and efficiency of data transmission. By handling the transformation of data formats and character sets, the presentation layer facilitates seamless communication between applications running on different systems. This layer may then abstract the complexities of data representation, enabling applications to exchange information without worrying about differences in data formats. In essence, the presentation layer plays a crucial role in ensuring interoperability and data integrity between diverse systems and applications within a networked environment.

In numerous embodiments, the communication layer architecture 200 may include an application layer as a seventh layer (denoted as “Layer 7” in FIG. 2). The application layer may serve as the interface between the network and the software applications that end-users interact with. It can provide a platform-independent environment for communication between diverse applications and ensures that data exchange is meaningful and understandable. The application layer can encompass a variety of protocols and services that support functions such as file transfers, email, remote login, and web browsing. It acts as a mediator, allowing different software applications to communicate seamlessly across a network. Some well-known application layer protocols include Hypertext Transfer Protocol (HTTP), File Transfer Protocol (FTP), and Simple Mail Transfer Protocol (SMTP). In essence, the application layer enables the development of network-aware applications by defining standard communication protocols and offering a set of services that facilitate robust and efficient end-to-end communication across networks.

Although a specific embodiment for the communication layer architecture 200 is described above with respect to FIG. 2, any of a variety of systems and/or processes may be utilized in accordance with embodiments of the disclosure. For example, various aspects described herein may reside or be carried out on one layer, or a plurality of layers. The elements depicted in FIG. 2 may also be interchangeable with other elements of FIG. 1 and FIGS. 3-12 as required to realize a particularly desired embodiment.

Referring to FIG. 3, a conceptual network diagram 300 of various environments in which a roaming management logic can operate on a plurality of network devices in accordance with various embodiments of the disclosure is shown. Those skilled in the art will recognize that the roaming management logic may include various hardware and/or software deployments and may be configured in a variety of ways. In many embodiments, the roaming management logic may be configured as a standalone device, exist as a logic in another network device, be distributed among various network devices operating in tandem, or be remotely operated as part of a cloud-based network management tool. In further embodiments, one or more servers 310 may be configured with the roaming management logic or may otherwise operate as the roaming management logic. In many further embodiments, the roaming management logic may operate on the one or more servers 310 connected to a communication network 320 (e.g., the “Internet”). The communication network 320 may include wired networks or wireless networks. The roaming management logic may be provided as a cloud-based service that may service remote networks, such as, but not limited to a deployed network 340.

However, in additional embodiments, the roaming management logic may be operated as a distributed logic across multiple network devices. In the embodiment depicted in FIG. 3, a plurality of APs 350 (interchangeably referred to the plurality of network devices 350) as may operate as the roaming management logic in a distributed manner or may have one specific device operate as the roaming management logic for all of the neighboring APs 350. The APs 350 may facilitate Wi-Fi connections for various electronic devices, such as but not limited to, client devices 360-390 (interchangeably referred to the wireless devices 360-390) including laptop computers 370, cellular phones 360, portable tablet computers 380, and wearable computing devices 390. In still additional embodiments, at least one client device of the client devices 360-390 may be configured with the roaming management logic or may otherwise operate as the roaming management logic.

In numerous embodiments, the roaming management logic may be integrated within another network device. In an example, a wireless LAN controller (WLC) 330 may be configured with the roaming management logic or may otherwise operate as the roaming management logic. The WLC 330 may control operations associated with a set of APs 335 that are connected, either wired or wirelessly, to the WLC 330. In more embodiments, a personal computer 325 may be utilized to access and/or manage various aspects of the roaming management logic, either remotely or within the network itself. In the embodiment depicted in FIG. 3, the personal computer 325 communicates over the communication network 320 and may access the roaming management logic of the servers 310, the APs 350, at least one client device of the client devices 360-390, or the WLC 330.

Although a specific embodiment for various environments that the roaming management logic may operate on a plurality of network devices suitable for carrying out the various steps, processes, methods, and operations described herein is discussed with respect to FIG. 3, any of a variety of systems and/or processes may be utilized in accordance with embodiments of the disclosure. In many non-limiting examples, the roaming management logic may be provided as a device or software separate from the APs 350 or the roaming management logic may be integrated into the APs 350. The elements depicted in FIG. 3 may also be interchangeable with other elements of FIGS. 1-2 and FIGS. 4-12 as required to realize a particularly desired embodiment.

Referring to FIG. 4, a conceptual network diagram 400 for providing roaming assistance to a wireless device 402 in accordance with various embodiments of the disclosure is shown. In the embodiments shown in FIG. 4, the conceptual network diagram 400 may include the wireless device 402, a network device 404 to which the wireless device 402 is currently associated, and a plurality of neighboring network devices 406A-406D, which are neighbors of the wireless device 402 and/or the network device 404. For the purpose of illustration, only four neighboring network devices (e.g., a first neighboring network device 406A, a second neighboring network device 406B, a third neighboring network device 406C, and a fourth neighboring network device 406D) are shown in FIG. 4. However, in actual implementations, neighboring network devices may be fewer or greater than four without deviating from the scope of the disclosure. In one or more embodiments, the network device 404 may communicate with the plurality of neighboring network devices 406A-406D, either over a Distribution System (DS) or over the air.

The wireless device 402 may include a mobile computing device such as a smartphone, a tablet, a laptop/notebook, a wearable device, a gaming console, an entertainment device, or any other similar device. In an example, the wireless device 402 may be equipped with one or more wireless connectivity features (such as Wi-Fi, Bluetooth, or cellular networks) to enable the wireless device 402 to connect to the Internet or other devices. Additionally, the wireless device 402 may be equipped with an Ultra-Wideband (UWB) function for various applications such as location tracking, object detection, or the like.

In a number of embodiments, the network device 404 may allow the wireless device 402 to connect to the Internet or other devices using Wi-Fi, Bluetooth, or the like. Specifically, the network device 404 may allow the wireless device 402 to connect to the Internet or other devices when the wireless device 402 is located within a cell 408 of the network device 404. In an example, the cell 408 may define a specific geographical area serviced by the network device 404.

In many embodiments, each of the wireless device 402 and the network device 404 may include one or more processors and a memory communicatively coupled to the processor(s). The processor(s) may include suitable logic, circuitry, and interfaces that are configured to execute instructions stored in the memory. For example, the processor(s) may correspond to an Application-Specific Integrated Circuit (ASIC) processor, a Complex Instruction Set Computing (CISC) processor, a Central Processing Unit (CPU), an Explicitly Parallel Instruction Computing (EPIC) processor, a Very Long Instruction Word (VLIW) processor, and/or other processors or circuits. The memory may comprise suitable logic, circuitry, and interfaces that are configured to store a machine code and/or the instructions executable by the processor. For example, the memory may correspond to Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a secure digital (SD) card.

In a variety of embodiments, each of the wireless device 402 and the network device 404 may include a communication interface that is communicatively coupled to the processor(s) and/or the memory. The communication interface may comprise suitable logic, circuitry, and interfaces configured to enable a device, such as the wireless device 402 or the network device 404, to interact with other devices. For example, the communication interface may correspond to a Wi-Fi interface, a Bluetooth interface, a UWB interface, or the like. Additionally, the network device 404 may include a network interface controller that includes suitable logic, circuitry, and interfaces configured to provide access to a network (such as the Internet). It will be understood by a person of ordinary skill in the art that each of the plurality of neighboring network devices 406A-406D may be functionally and/or structurally similar to the network device 404.

In further embodiments, the wireless device 402 and the network device 404 may be equipped with a roaming management logic 410A and a roaming management logic 410B, respectively. The roaming management logic 410A may be embodied in the memory of the wireless device 402 or in any of the processor(s) of the wireless device 402, or embodied as a standalone unit in the wireless device 402. Similarly, the roaming management logic 410B may be embodied in the memory of the network device 404 or in any of the processor(s) of the network device 404, or embodied as a standalone unit in the network device 404.

In still further embodiments, the wireless device 402 may be configured to establish an association (or a communication link) with the network device 404 when the wireless device 402 is in the vicinity of the network device 404. In order to establish the association with the network device 404, the wireless device 402 may transmit an authentication request to the network device 404. For example, the authentication request may include an open system authentication request or a Pre-Shared Key (PSK) authentication request. Upon receiving the authentication request, the network device 404 may authenticate the wireless device 402 based on the received authentication request. After the successful authentication, the network device 404 may send an authentication response indicating an authentication successful message to the wireless device 402. Upon receiving the authentication response, the wireless device 402 may send an association request to the network device 404. In an example, the association request may indicate that the wireless device 402 wants to be a part of a network associated with the network device 404. Upon receiving the association request, the network device 404 may allow the wireless device 402 to join the network. Additionally, the wireless device 402 and the network device 404 may perform a handshake protocol (for example, a 4-way Handshake protocol) to establish a secure connection between the wireless device 402 and the network device 404. In more embodiments, the network device 404 may transmit an authentication request to the wireless device 402 to establish an association (or a communication link) with the wireless device 402 in a similar manner as described above.

Upon establishing the association with the network device 404, the wireless device 402 may be configured to monitor one or more signal metrics associated with a wireless signal of the wireless device 402 to determine a roaming status of the wireless device 402. For example, the one or more signal metrics may include a Received Signal Strength Indicator (RSSI) value associated with the wireless signal, a Signal-to-Noise Ratio (SNR) value associated with the wireless signal, or the like. In an example, the roaming status of the wireless device 402 may indicate whether the wireless device 402 is approaching an edge of the cell 408 or not. For example, the wireless device 402 may determine that the wireless device 402 is approaching the edge of the cell 408 when the one or more signal metrics fall below a threshold signal metric. Conversely, when the one or more signal metrics do not fall below the threshold signal metric, the wireless device 402 may determine that the wireless device 402 is not approaching the edge of the cell 408.

In still more embodiments, when the roaming status of the wireless device 402 indicates that the wireless device 402 is approaching the edge of the cell 408, the wireless device 402 may be configured to generate a roaming assistance request. For example, the roaming assistance request may seek information about neighboring network devices, such as the plurality of neighboring network devices 406A-406D, to facilitate Wi-Fi roaming. Additionally, the roaming assistance request may seek a recommendation for the next network device to which the wireless device 402 may roam after disconnecting from the network device 404. For example, the next network device may be any device from the plurality of neighboring network devices 406A-406D.

In one or more embodiments, the roaming assistance request may include a zero-scan assistance flag, requesting zero-scan assistance or zero-scan roaming, which is intended to minimize the scanning efforts required by the wireless device 402 to identify a neighboring network device (for example, any device from the plurality of neighboring network devices 406A-406D) with which the wireless device 402 can establish a connection as the wireless device 402 moves out of the cell 408, or in scenarios where connection with the neighboring network device is required for reasons such as load balancing, improved network performance, network coverage optimization, or other network management considerations.

In additional embodiments, the roaming assistance request may include at least one of a BTM query defined in the 802.11v standard or a neighbor report request defined in the 802.11k standard. In still additional embodiments, the roaming assistance request may be configured to indicate at least one traffic type that the wireless device 402 is to transmit. For example, the traffic type may indicate a real-time or near-real-time traffic requirement, necessitating specific scheduling considerations for traffic management.

In numerous embodiments, the roaming assistance request may include an indication of at least one of a set of movement characteristics or a set of location characteristics of the wireless device 402. For example, the set of movement characteristics may refer to one or more parameters that describe the motion of the wireless device 402, such as speed, direction, acceleration, and movement path. The set of movement characteristics may be utilized to determine a current movement path of the wireless device 402 and to predict a future movement path of the wireless device 402. Additionally, the set of location characteristics may refer to one or more parameters that describe spatial attributes and positioning of the wireless device 402, such as geographic coordinates (latitude and longitude) and distance from a reference point (e.g., the network device 404). The set of location characteristics may be utilized to determine a current location of the wireless device 402 and to predict a future location of the wireless device 402.

In one example, the indication may include a flag indicative of one of a moving state or a stationary state of the wireless device 402. A “moving state” flag may be set when the wireless device 402 is actively changing its position within the cell 408, while a “stationary state” flag may be set when the wireless device 402 is not moving and remains in a fixed location. In one or more embodiments, the wireless device 402 may determine its moving or stationary state based on data from a Global Positioning System (GPS) and/or one or more inertial sensors.

In more examples, the indication may include a geographical location of the wireless device 402. The wireless device 402 may compute its geographical location based on one or more geo-positioning methods, such as Global Navigation Satellite System (GNSS), Fine Time Measurement (FTM), dead reckoning, or other similar techniques.

In still more examples, the indication may include a range to the network device 404 (for example, a distance between the network device 404 and the wireless device 402). The range to the network device 404 may be determined based on a feedback mechanism, such as 802.11az Location Measurement Report (LMR), which allows the wireless device 402 to report its distance to the network device 404 based on a series of location measurements. Additional or alternate methods to determine the range to the network device 404, such as UWB or Bluetooth Low Energy (BLE), may also be considered.

In yet more examples, the indication may include a set of values representing one of a location of the wireless device 402 or a movement of the wireless device 402. In examples, at least one value in the set of values may represent one of an acceleration of the wireless device 402, a direction of the wireless device 402, or a speed of the wireless device 402. Further, a value in the set of values may represent a vector. The vector may represent various movement parameters including one or more of the acceleration of the wireless device 402, the direction of the wireless device 402, or the speed of the wireless device 402. In an example, the acceleration may be represented either instantaneously or as an average over a specified interval. The set of values may represent a change in position of the wireless device 402 relative to a last reported position, where a value in the set of values may represent time elapsed since the last reported position. The set of values may further include short descriptors of the movement of the wireless device 402. Additionally, an index may represent the direction of movement of the wireless device 402, either relative to the network device 404 or as a global direction (e.g., 268 degrees, referencing a 360-degree compass). In several examples, the acceleration of the wireless device 402 may be represented by values, such as Cn, which enable the computation of the speed of the wireless device 402 through integration and, subsequently, the determination of the new position of the wireless device 402. In further examples, the wireless device 402 and the network device 404 may establish a movement equation (for example, an enhanced Kalman filter), with the wireless device 402 reporting the changing variables of the equation (e.g., state changes), thereby facilitating the prediction and tracking of the movement of the wireless device 402.

In still additional embodiments, upon generating the roaming assistance request, including the indication of at least one of the set of movement characteristics or the set of location characteristics of the wireless device 402, the wireless device 402 may be configured to transmit the roaming assistance request to the network device 404. In numerous embodiments, the wireless device 402 may transmit the roaming assistance request in at least one of an action frame or a wireless frame. In an example, the wireless frame may be one of an Advanced Service Request (ASR) or a Service Classification Signal (SCS).

In yet various embodiments, the wireless device 402 and the network device 404 may establish an agreement on a method for the network device 404 to obtain information about the location and/or the movement of the wireless device 402 without the wireless device 402 directly sharing information about the location and/or the movement. Such an agreement can be established at various instances, for example, during association, during security updates, during a handover process, or during one or more network maintenance sessions.

In an example of such agreed method, the network device 404 may receive one or more RF parameters of the wireless device 402 relative to at least one neighboring network device (for example, any device from the plurality of neighboring network devices 406A-406D) from the wireless device 402 and/or the at least one neighboring network device. The one or more RF parameters may include a Received Signal Strength Indicator (RSSI), a Signal-to-Noise Ratio (SNR), or similar metrics. The one or more RF parameters may be utilized to estimate the location and/or movement of the wireless device 402, including its direction, speed, or distance from the plurality of neighboring network devices 406A-406D, without the need for explicit location or motion information sharing by the wireless device 402.

In such example embodiment, at a time determined by the network device 404, or at a time agreed upon between the wireless device 402 and the network device 404, and while the wireless device 402 maintains the connection with network device 404, the network device 404 may instruct the wireless device 402 to perform a scan on a channel utilized by a neighboring network device. For example, the neighboring network device may be any device from the plurality of neighboring network devices 406A-406D. For clarity and brevity, the following description will be detailed with respect to the neighboring network device 406B. However, the description is equally applicable to the other neighboring network devices, which may include similar or equivalent components and functionality.

In further more embodiments, the neighboring network device 406B may have an active radio, and the wireless device 402 may transmit a probe request to the neighboring network device 406B. The neighboring network device 406B may receive the probe request from the wireless device 402 and, in response, transmit a probe response to the wireless device 402 (for example, in response to the probe request). In yet more embodiments, the wireless device 402 may tune to the channel of the neighboring network device 406B and detect one of a beacon response or a probe response, which may be unsolicited. In still yet more embodiments, the wireless device 402 may tune to the radio of the neighboring network device 406B and transmit a frame to the neighboring network device 406B. However, the wireless device 402 may not receive a response, for example, because the channel is being used by the neighboring network device 406B for monitoring purposes. In many further embodiments, the neighboring network device 406B may tune its radio to the same channel as the network device 404 and monitor communication exchange between the wireless device 402 and the network device 404, as well as signal levels corresponding to the wireless device 402 and the network device 404. Based on the communication exchange and the corresponding signal levels, the neighboring network device 406B may calculate the distance between the wireless device 402 and the neighboring network device 406B.

In still yet further embodiments, when the wireless device 402 receives a response from the neighboring network device 406B, such as in response to the transmitted frame, the response may include a corresponding signal level (for example, RSSI). In yet several embodiments, the wireless device 402 may report the response, along with the corresponding signal level as the RF parameters, to the network device 404, for example, via an 802.11k beacon report. In an example, the roaming assistance request transmitted by the wireless device 402 may include one or more RF parameters associated with the wireless device 402 relative to the at least one neighboring network device from the plurality of neighboring network devices 406A-406D.

In several additional embodiments, when the wireless device 402 does not receive a response to the transmitted frame, but the neighboring network device 406B detects the frame sent by the wireless device 402, or when the wireless device 402 does receive the response and report to the network device 404, the neighboring network device 406B may communicate detected one or more RF parameters (e.g. RSSI) corresponding to the wireless device 402 to the network device 404.

In a number of embodiments, the network device 404 may obtain at least one of the motion data or the location data of the wireless device 402 based on the indication of at least one of the set of movement characteristics or the set of location characteristics of the wireless device 402, or based on the one or more RF parameters of the wireless device 402 relative to the at least one neighboring network device (for example, any device from the plurality of neighboring network devices 406A-406D). For example, the motion data may include details about the speed of the wireless device 402 (for example, the rate of movement), the movement path of the wireless device 402 (for example, the direction), and changes in velocity over time (for example, the acceleration). The location data may provide information about the geographic position of the wireless device 402, as well as the distance between the wireless device 402 and a network device, such as network device 404 or one of the plurality of neighboring network devices 406A-406D.

In a variety of embodiments, the network device 404, utilizing prior training (such as through Artificial Intelligence (AI), Machine Learning (ML), or other techniques), may determine the direction of the wireless device 402 based on the scan performed by the wireless device 402. For example, consider a scenario where the network device 404 is positioned in a corridor alongside the neighboring network device 406A, and the network device 404 and the neighboring network devices 406B are aligned along the same path. The network device 404 may already have information of the RSSI corresponding to the wireless device 402 when the wireless device 402 is detected by the neighboring network device 406A, particularly when the wireless device 402 is located beneath the network device 404. Using this information, the network device 404 may analyze the RSSI received by the neighboring network devices 406A to determine the direction of movement of the wireless device 402, such as whether the wireless device 402 is moving towards the neighboring network device 406A or the neighboring network device 406B.

In further embodiments, a single scan may not provide adequate information to accurately determine the direction, speed, or acceleration of the wireless device 402. To address this, the scanning process may be repeated multiple times, gathering additional data (or measurement data) to improve accuracy. The additional data may allow the network device 404 to obtain motion data and/or location data about the wireless device 402 accurately, even in scenarios where the wireless device 402 is incapable of or not configured to report information about speed, direction, and/or acceleration.

In still further embodiments, the network device 404 may generate a list of one or more neighboring network devices based on the obtained at least one of the motion data or the location data of the wireless device 402. For example, the network device 404 may utilize the motion data and/or the location data to evaluate the proximity of the plurality of neighboring network devices 406A-406D relative to the wireless device 402. Specifically, the network device 404 may assess the movement path, speed, and/or acceleration of the wireless device 402 to predict which neighboring network devices are within its range or in the path of the wireless device 402 as it moves. Additionally, the network device 404 may utilize the location data, such as geographic coordinates, to identify neighboring network devices by comparing the position of the wireless device 402 with the positions of the neighboring network devices. This information may allow the network device 404 to generate the list of one or more neighboring network devices that the wireless device 402 may potentially connect to, based on its current location or predicted movement. For an example, the list of one or more neighboring network devices may include the neighboring network device 406A, the neighboring network device 406B, and the neighboring network device 406C. On the other hand, the neighboring network device 406D may be located farther away from the current location of the wireless device 402 and may not be within the predicted movement path of the wireless device 402. Additionally, based on the speed and direction of movement, the wireless device 402 is unlikely to approach the neighboring network device 406D. As a result, since neighboring network device 406D is either out of range or not expected to be within the movement path of the wireless device 402, the neighboring network device 406D may not be included in the generated list. As shown in FIG. 4, the neighboring network device 406A, the neighboring network device 406B, and the neighboring network device 406C are positioned ahead of the wireless device 402 along its movement path 412, while the neighboring network device 406D is positioned farther away from the wireless device 402, opposite to the movement path 412 of the wireless device 402. As a result, the neighboring network device 406A, the neighboring network device 406B, and the neighboring network device 406C are included in the generated list, while the neighboring network device 406D is not included in the generated list. It should be appreciated that 406C, for example, need not be limited to Wi-Fi. Indeed, in scenarios where no suitable Wi-Fi neighbors are detected, such as when coverage is sparse or signal quality is inadequate, may instead correspond to a cellular base station, a Bluetooth beacon, a mesh node, or another compatible radio technology capable of supporting connectivity or assisting in handover decisions. This flexibility allows the dynamically adaptability to heterogeneous wireless environments.

In many further embodiments, the generated list is ordered by priority, with neighboring network devices that are more likely to provide optimal connectivity placed higher on the list and neighboring network devices that are less likely to provide optimal connectivity placed lower on the list. For example, the list may prioritize the neighboring network device 406A, the neighboring network device 406B, and the neighboring network device 406C, which are positioned ahead of the wireless device 402 along the movement path 412, while excluding the neighboring network device 406D, which is either out of range or unlikely to be within the predicted movement path of the wireless device 402. The list may be ordered based on factors such as roaming probability, signal strength, or likelihood of coverage, ensuring that the wireless device 402 can quickly and efficiently connect to the most optimal neighboring network device.

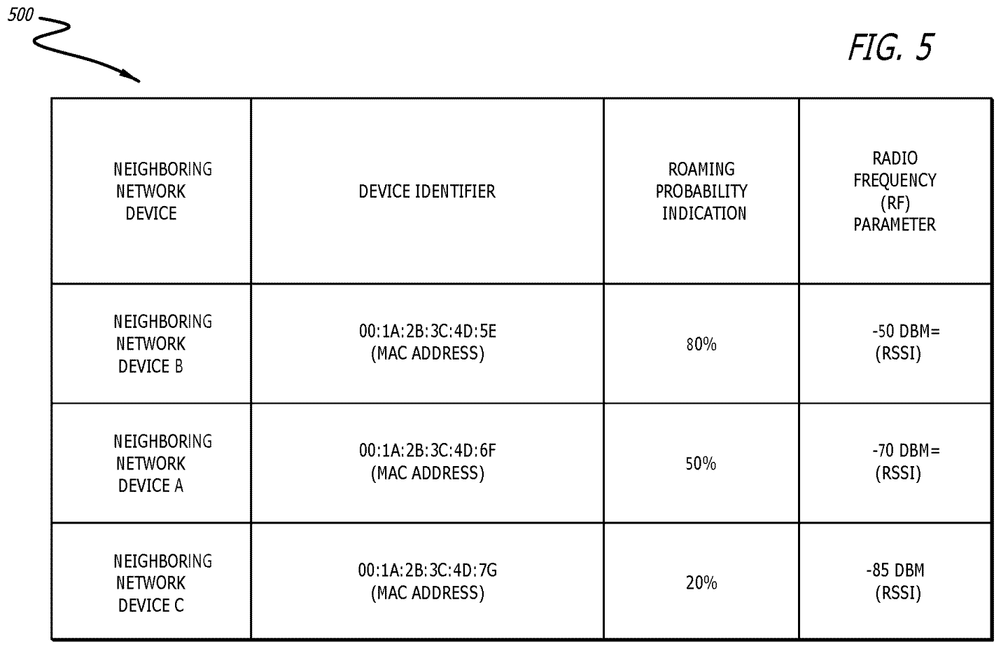

In more embodiments, the network device 404 may transmit, for roaming assistance, the list of one or more neighboring network devices to the wireless device 402, for example, when the wireless device 402 approaches the edge of the cell 408 and/or when the network device 404 receives the roaming assistance request from the wireless device 402. The network device 404 may transmit the list of one or more neighboring network devices to the wireless device 402 in one of a BTM message (for example, a targeted 802.11v BTM message) or a neighbor report (for example, 802.11k neighbor report). For example, the network device 404 may be configured to transmit a signal strength indicator (for example, RSSI) to the wireless device 402, corresponding to a mid-point between the network device 404 and a neighboring network device in the list of one or more neighboring network devices. Additionally, the network device 404 may be configured to transmit a roaming probability indication to the wireless device 402 for at least one neighboring network device in the list of one or more neighboring network devices. The generated list will be described in greater detail with reference to FIG. 5.

In additional embodiments, if the movement of the wireless device 402 cannot be determined or is unknown, the network device 404 may generate a list of one or more neighboring network devices based on historical roaming patterns of other wireless devices (for example, other than the wireless device 402). For example, the generated list may include a count of the top N neighboring network devices from which other wireless devices typically roam, such as those typically roaming from the network device 404. The generated list may also include a percentage of wireless devices that have roamed to each of the top N neighboring network devices. Additionally, the list may include information derived from modeling data that describes roaming patterns. For example, the roaming patterns could be based on statistical data collected over a defined period, such as samples gathered over a six-month span, covering a large number of roaming events (e.g., 60,000 roams). This data may help identify the top N neighboring network devices that the wireless device 402 can roam to, even in the absence of real-time movement data. The generated list may also include additional contextual information, such as the network device density for a specific floor or area. For example, data may indicate that the neighboring network devices or BSAs are typically located at mid-points with signal levels around-68 dBm from the network device 404. This enables the wireless device 402 to make an informed decision about the most likely neighboring network devices to connect to when roaming. This approach optimizes the roaming process by relying on historical data, thereby minimizing the need for real-time movement information and enabling more accurate predictions of the roaming behavior of the wireless device 402, which ensures smoother handovers and a better user experience.

In a number of embodiments, the wireless device 402 may receive, for roaming assistance, the list of one or more neighboring network devices from the network device 404. In an example, the list of one or more neighboring network devices may be based on at least one of the motion data or the location data of the wireless device 402. As described above, the list may include the signal strength indicator (for example, RSSI), corresponding to the mid-point between the network device 404 and the neighboring network device in the list of one or more neighboring network devices. In an example, as the wireless device 402 moves and approaches the edge of the cell 408, the wireless device 402 may evaluate the available neighboring network devices to decide which one to connect to. If the signal strength between the wireless device 402 and a neighboring network device is balanced (for example, indicated by an RSSI at the mid-point), the wireless device 402 may be in a transition zone where both the network device 404 and the neighboring device are viable candidates for maintaining a connection. By considering this balanced signal strength, unnecessary or untimely switching between the wireless device 402 and the neighboring network device is avoided. This may allow a smoother transition to the neighboring network device when needed. This results in more efficient roaming, as the wireless device 402 can maintain a stable connection while moving from one coverage area to the next, optimizing performance and user experience.

In further embodiments, the wireless device 402 may perform a scan for at least one neighboring network device in the list of one or more neighboring network devices. For example, the wireless device 402 may perform a scan to detect at least one neighboring network device from the list of neighboring network devices. For example, the wireless device 402 may prioritize scanning the neighboring network device 406A and the neighboring network device 406B, which are ranked higher in the list, while excluding the neighboring network device 406C, which appears lower in the list based on its ranking.

In additional embodiments, the wireless device 402 may provide feedback to the network device 404. For example, the feedback may include information such as “Neighboring network device A not found” or “RSSI of neighboring network device C too low”. In one or more embodiments, the wireless device 402 may provide the feedback to the network device 404 (for example, in case of a roaming failure) or to a neighboring network device (for example, in case of a successful, but suboptimal roam). In several embodiments, the network device 404 may receive the feedback on the roaming assistance from the wireless device 402 in response to the transmission of the list of one or more neighboring network devices. By receiving the feedback from the wireless device 402, the network device 404 may improve roaming support, enhancing the accuracy and efficiency of future handoffs. This dynamic feedback loop may enable optimized connectivity by addressing issues such as failed or suboptimal roams in real-time.

Although a specific embodiment of the conceptual network diagram 400 for providing roaming assistance to a wireless device for carrying out the various steps, processes, methods, and operations described herein is discussed with respect to FIG. 4, any of a variety of systems and/or processes may be utilized in accordance with embodiments of the disclosure. For example, the network device 404 may transmit the list of one or more neighboring network devices to the wireless device 402 unsolicited. In such a scenario, the network device 404 may not receive the roaming assistance request from the wireless device 402. The elements depicted in FIG. 4 may also be interchangeable with other elements of FIGS. 1-3 and 5-12 as required to realize a particularly desired embodiment.

Referring to FIG. 5, a diagram of a list 500 of a plurality of neighboring network devices in accordance with various embodiments of the disclosure is shown. FIG. 5 is described in conjunction with FIG. 4.

In various embodiments, the list 500 may be received by a wireless device (for example, the wireless device 402) from a network device (for example, the network device 404) with which the wireless device is currently associated. In an example, the list 500, generated by the network device, may include information about three neighboring network devices, including a neighboring network device A, a neighboring network device B, and a neighboring network device C. These neighboring network devices are arranged in a priority order, with the most optimal neighboring network device listed at the top to facilitate seamless Wi-Fi roaming. This ordering may enable the wireless device to efficiently select the most optimal neighboring network device as the wireless device may move out of the coverage area of the currently associated network device, ensuring a stable and continuous connection. For the sake of clarity and explanation, the list 500 is illustrated to include three neighboring network devices. However, it should be understood that the list 500 may include fewer or more than three neighboring network devices, depending on the specific implementation.

In the embodiments shown in FIG. 5, the list 500 may include one or more Information Elements (IEs), for example, a device identifier IE, a roaming probability indication IE, and an RF parameter IE. The device identifier IE may indicate a BSSID (for example, a MAC address of a Wi-Fi interface) of a neighboring network device. The roaming probability indication IE may indicate, for example, the likelihood (expressed as a percentage) that the wireless device will transition to a particular neighboring network device, assisting the wireless device in making informed decisions for seamless roaming. The RF parameter IE may indicate the signal strength (for example, an RSSI value) of the wireless device relative to a neighboring network device. In an example, the RF parameter IE may correspond to a signal strength indicator corresponding to a mid-point between the network device and the neighboring network device. Additionally, each IE may have one or more associated fields including specific information about a particular neighboring network device.

As shown in FIG. 5, for the neighboring network device A, the field corresponding to the device identifier IE may indicate the MAC address “00:1A:2B:3C:4D:6F”, the field corresponding to the roaming probability indication IE may indicate a roaming probability of 50 percent, and the field corresponding to the RF parameter IE may indicate an RSSI value of −70 dBm. For the neighboring network device B, the field corresponding to the device identifier IE may indicate the MAC address “00:1A:2B:3C:4D:5EF”, the field corresponding to the roaming probability indication IE may indicate a roaming probability of 80 percent, and the field corresponding to the RF parameter IE may indicate an RSSI value of −50 dBm. For the neighboring network device C, the field corresponding to the device identifier IE may indicate a MAC address “00:1A:2B:3C:4D:7G”, the field corresponding to the roaming probability indication IE may indicate a roaming probability of 20 percent, and the field corresponding to the RF parameter IE may indicate an RSSI value of −85 dBm.

In an example, the RF parameter IE may correspond to the signal strength indicator for indicating mid-point. In such examples, the RSSI value of −70 dBm for the neighboring network device A may indicate that when the wireless device receives the RSSI value of −70 dBm from the connected network device, the wireless device is located at a potential mid-point between the network device and the neighboring network device A. Likewise, the RSSI value of −50 dBm for the neighboring network device B may indicate that when the wireless device receives the RSSI value of −50 dBm from the connected network device, the wireless device is located at a potential mid-point between the network device and the neighboring network device B. Further, the RSSI value of −85 dBm for the neighboring network device C may indicate that when the wireless device receives the RSSI value of −85 dBm from the connected network device, the wireless device is located at a potential mid-point between the network device and the neighboring network device C.

The list 500 is arranged in a prioritized order, with the most optimal neighboring network device, in this case, the network neighboring device B, listed at the top, followed by the network neighboring device A, and then the network neighboring device C. This prioritization is determined based on factors such as roaming probability, signal strength, and other performance metrics, ensuring that the wireless device can efficiently select the most optimal neighboring network device for seamless connectivity.

In a variety of embodiments, in response to receiving the list 500, the wireless device may perform a scan to evaluate the neighboring network devices included in the list 500. During the scan, the wireless device may determine that the neighboring network device B has a roaming probability of 80% and an RSSI of −50 dBm, making it a strong candidate for Wi-Fi roaming. In contrast, the neighboring network device C has a roaming probability of only 20% and a weaker RSSI of −85 dBm, making it a less likely choice. Based on the results of the scan, the wireless device may prioritize the neighboring network device B for the handover due to its high roaming probability and strong signal strength, ensuring a smooth transition to a stable connection as the wireless device moves out of the coverage area of the network device.

Accordingly, the network device provides tailored information to the wireless device (for example, in the form of the list 500), significantly reducing the need for extensive scanning by the wireless device at the edge of the cell. This results in a more efficient roaming process, minimizing delays and improving the overall user experience.

Although a specific embodiment of the list 500 for carrying out the various steps, processes, methods, and operations described herein is discussed with respect to FIG. 5, any of a variety of systems and/or processes may be utilized in accordance with embodiments of the disclosure. For example, it is to be understood that the list of neighboring network devices, as described in the present disclosure, may contain any number of Information Elements (IEs) and associated fields. The specific number and type of IEs and fields included in the list are not limited to those detailed in this disclosure and may be adapted or extended based on the particular system configuration or use case requirements. The elements depicted in FIG. 5 may also be interchangeable with other elements of FIGS. 1-4 and 6-12 as required to realize a particularly desired embodiment.

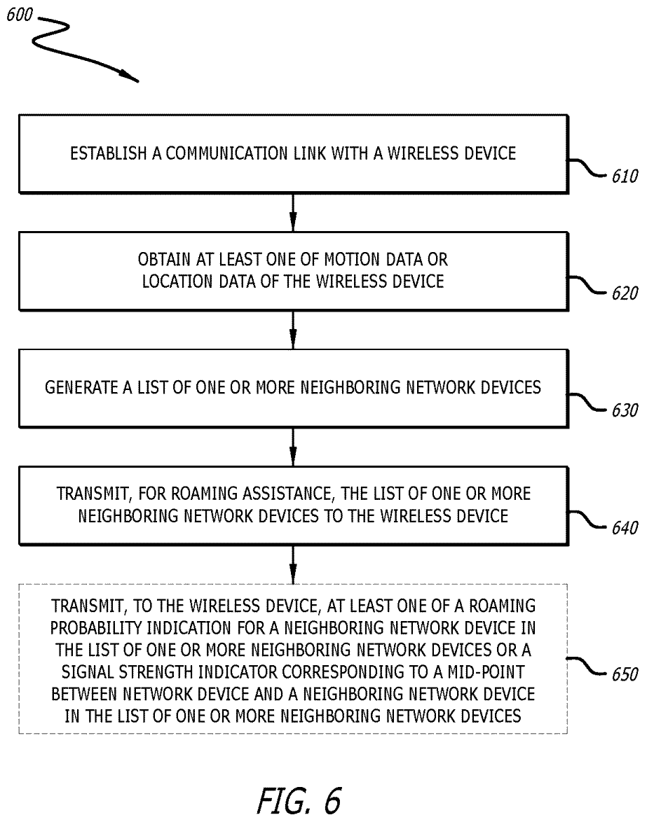

Referring to FIG. 6, a flowchart depicting a process 600 for generating a list of one or more neighboring network devices in accordance with various embodiments of the disclosure is shown. In several embodiments, the process 600 may be implemented in a network device. For example, the network device may be an access point.

In many embodiments, the process 600 may establish a communication link with the wireless device (block 610). In an example, the wireless device may transmit an authentication request to the network device. For example, the authentication request may include an open system authentication request or a PSK authentication request. Upon receiving the authentication request, the network device may authenticate the wireless device based on the received authentication request. After the successful authentication, the network device may send an authentication response indicating an authentication successful message to the wireless device. Upon receiving the authentication response, the wireless device may send an association request to the network device. Upon receiving the association request, the network device may allow the wireless device to join the network. Additionally, the network device may perform a handshake protocol (for example, a 4-way Handshake protocol) with the wireless device to establish the communication link with the wireless device.

In a number of embodiments, the process 600 may obtain at least one of motion data or location data of the wireless device (block 620). The process 600 may receive a roaming assistance request from the wireless device. The roaming assistance request may include an indication of at least one of a set of movement characteristics or a set of location characteristics of the wireless device. In an example, the indication may include a flag indicative of one of a moving state or a stationary state of the wireless device. In another example, the indication may include a geographical location of the wireless device. In yet another example, the indication may include a distance between the network device and the wireless device. In some examples, the indication may include a set of values representing one of a location of the wireless device or a movement of the wireless device. In an example, at least one value in the set of values may represent one of an acceleration of the wireless device, a direction of the wireless device, or a speed of the wireless device. Further, a value in the set of values may represent a vector including one or more of the acceleration of the wireless device, the direction of the wireless device, or the speed of the wireless device. In numerous embodiments, the process 600 may obtain at least one of the motion data or the location data of the wireless device based on the indication of at least one of the set of movement characteristics or the set of location characteristics of the wireless device.

In a variety of embodiments, the process 600 may generate a list of one or more neighboring network devices (block 630). The process 600 may generate the list of one or more neighboring network devices based on the obtained at least one of the motion data or the location data of the wireless device. In an example, the generated list may be ordered by priority, with neighboring network devices that are more likely to provide optimal connectivity placed higher on the list and neighboring network devices that are less likely to provide optimal connectivity placed lower on the list. The list may be ordered based on factors such as roaming probability, signal strength, or likelihood of coverage, ensuring that the wireless device can quickly and efficiently connect to the most optimal neighboring network device.

In further embodiments, the process 600 may transmit, for roaming assistance, the list of one or more neighboring network devices to the wireless device (block 640). For example, the process 600 may transmit the list of one or more neighboring network devices to the wireless device in a basic service set (BSS) transition management (BTM) message. In another example, the process 600 may transmit the list of one or more neighboring network devices to the wireless device in a neighbor report.

In still further embodiments, the process 600 may transmit, to the wireless device, at least one of a roaming probability indication for a neighboring network device in the list of one or more neighboring network devices or a signal strength indicator corresponding to a mid-point between network device and a neighboring network device in the list of one or more neighboring network devices (block 650). The roaming probability indication may, for example, indicate the likelihood (expressed as a percentage) that the wireless device will transition to a particular neighboring network device, assisting the wireless device in making informed decisions for seamless roaming. Additionally, if the signal strength between the wireless device and a neighboring network device is balanced (for example, indicated by an RSSI at the mid-point), the wireless device may be in a transition zone where both the network device and the neighboring device are viable candidates for maintaining a connection. By considering this balanced signal strength, unnecessary or untimely switching between the wireless device and the neighboring network device is avoided. This ensures a smoother transition to the neighboring network device when needed. In one or more embodiments, transmitting the at least one of the roaming probability indication for the neighboring network device in the list of one or more neighboring network devices or the signal strength indicator corresponding to the mid-point between network device and the neighboring network device in the list of one or more neighboring network devices may be optional.

Although a specific embodiment for generating a list of one or more neighboring network devices suitable for carrying out the various steps, processes, methods, and operations described herein is discussed with respect to FIG. 6, any of a variety of systems and/or processes may be utilized in accordance with embodiments of the disclosure. For example, the process 600 may receive a roaming assistance request from the wireless device and in response to receiving the roaming assistance request, the process 600 may obtain at least one of motion data or location data of the wireless device, generate a list of one or more neighboring network devices, and transmit the list of one or more neighboring network devices to the wireless device. Additionally, the elements depicted in FIG. 6 may also be interchangeable with other elements of FIGS. 1-5 and FIGS. 7-12 as required to realize a particularly desired embodiment.

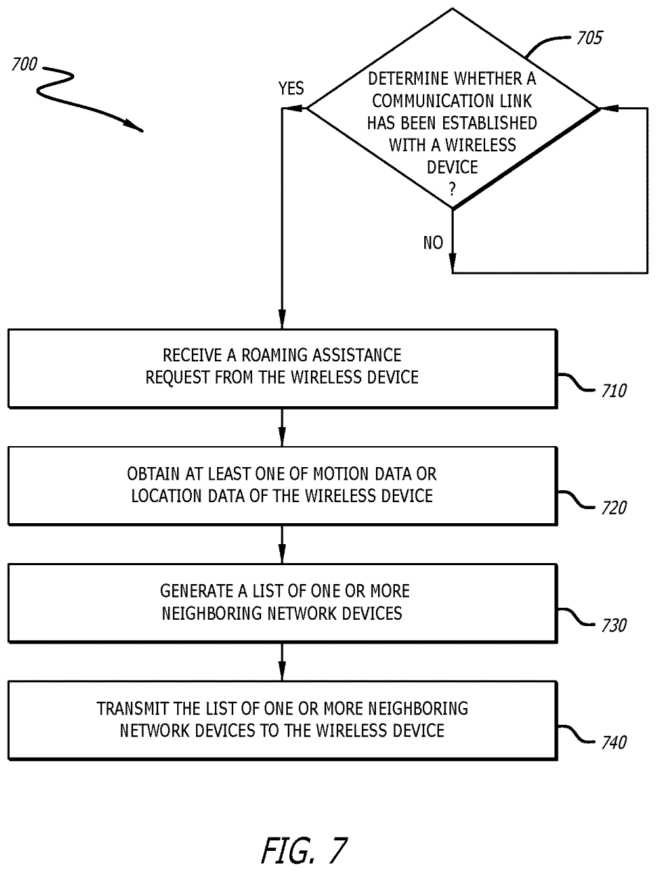

Referring to FIG. 7, a flowchart depicting a process 700 for transmitting a list of one or more neighboring network devices to a wireless device in accordance with various embodiments of the disclosure is shown. In many embodiments, the process 700 may be implemented in a network device. For example, the network device may be an access point.

In several embodiments, the process 700 may determine whether a communication link has been established with a wireless device (block 705). In one or more embodiments, the process 700 may determine whether the communication link has been established with the wireless device based on performing an action such as verifying an exchange of a handshake or confirmation signal between the wireless device and the network device. In an example, if the exchange of the handshake is confirmed, then the process 700 may determine that the communication link has been established with the wireless device. In another example, if the exchange of the handshake is not confirmed, then the process 700 may determine that the communication link has not been established with the wireless device.

If it is determined that the communication link has been established with the wireless device, in more embodiments, the process 700 may continue to determine whether the communication link has been established with the wireless device (block 705). If it is determined that the communication link has been established with the wireless device, in still more embodiments, the process 700 may receive a roaming assistance request from the wireless device (block 710). The roaming assistance request may include an indication of at least one of a set of movement characteristics or a set of location characteristics of the wireless device. In an example, the indication may include a flag indicative of one of a moving state or a stationary state of the wireless device. In another example, the indication may include a geographical location of the wireless device. In yet another example, the indication may include a distance between the network device and the wireless device. In some examples, the indication may include a set of values representing one of a location of the wireless device or a movement of the wireless device. In an example, at least one value in the set of values may represent one of an acceleration of the wireless device, a direction of the wireless device, or a speed of the wireless device. Further, a value in the set of values may represent a vector including one or more of the acceleration of the wireless device, the direction of the wireless device, or the speed of the wireless device.

In additional embodiments, the process 700 may obtain at least one of motion data or location data of the wireless device (block 720). The process 700 may obtain the at least one of the motion data or the location data of the wireless device based on the indication of at least one of the set of movement characteristics or the set of location characteristics of the wireless device. For example, the motion data may include details about the speed of the wireless device (for example, the rate of movement), the movement path of the wireless device (for example, the direction), and changes in velocity over time (for example, the acceleration). Additionally, the location data may provide information about the geographic position of the wireless device, as well as the distance between the wireless device and a network device, such as the network device or one of the plurality of neighboring network devices.

In still additional embodiments, the process 700 may generate a list of one or more neighboring network devices (block 730). The process 700 may generate the list of one or more neighboring network devices based on the obtained at least one of the motion data or the location data of the wireless device. In an example, the generated list may be ordered by priority, with neighboring network devices that are more likely to provide optimal connectivity placed higher on the list and neighboring network devices that are less likely to provide optimal connectivity placed lower on the list. The list may be ordered based on factors such as roaming probability, signal strength, or likelihood of coverage, ensuring that the wireless device can quickly and efficiently connect to the most optimal neighboring network device.

In numerous embodiments, the process 700 may transmit the list of one or more neighboring network devices to the wireless device (block 740). For example, the process 700 may transmit the list of one or more neighboring network devices to the wireless device in a BTM message. In another example, the process 700 may transmit the list of one or more neighboring network devices to the wireless device in a neighbor report.

Although a specific embodiment for transmitting a list of one or more neighboring network devices to a wireless device suitable for carrying out the various steps, processes, methods, and operations described herein is discussed with respect to FIG. 7, any of a variety of systems and/or processes may be utilized in accordance with embodiments of the disclosure. For example, the process 700 may receive a feedback from the wireless device on the roaming assistance. Additionally, the elements depicted in FIG. 7 may also be interchangeable with other elements of FIGS. 1-6 and FIGS. 8-12 as required to realize a particularly desired embodiment.

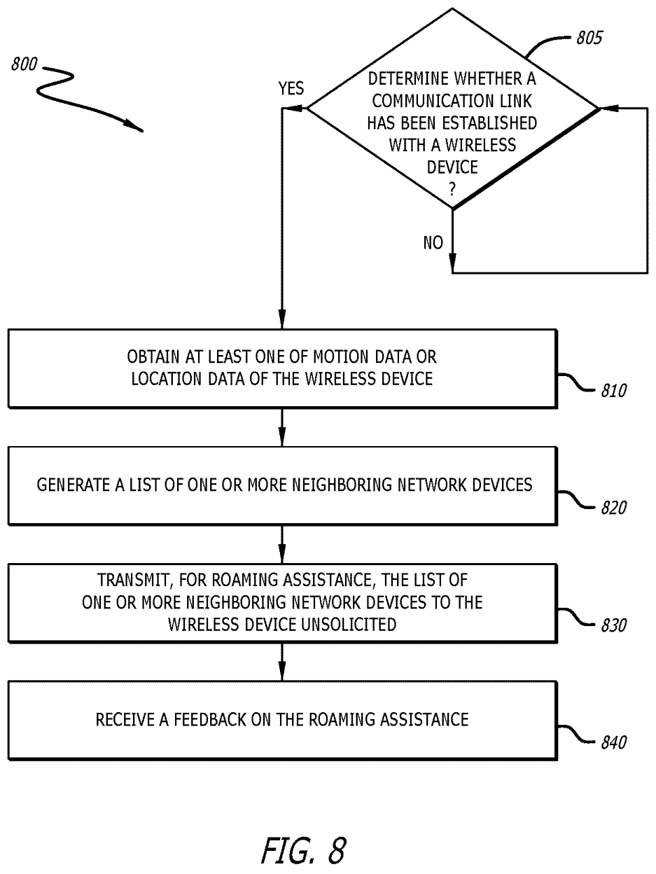

Referring to FIG. 8, a flowchart depicting a process 800 for receiving a feedback on roaming assistance from a wireless device in accordance with various embodiments of the disclosure is shown. In many embodiments, the process 800 may be implemented in a network device. For example, the network device may be an access point.

In more embodiments, the process 800 may determine whether a communication link has been established with a wireless device (block 805). In one or more embodiments, the process 800 may determine whether the communication link has been established with the wireless device based on performing an action such as verifying an exchange of a handshake or confirmation signal between the wireless device and the network device. In an example, if the exchange of the handshake is confirmed, then the process 800 may determine that the communication link has been established with the wireless device. In another example, if the exchange of the handshake is not confirmed, then the process 800 may determine that the communication link has not been established with the wireless device.

If it is determined that the communication link has been established with the wireless device, in further more embodiments, the process 800 may continue to determine whether the communication link has been established with the wireless device (block 805). If it is determined that the communication link has been established with the wireless device, in yet more embodiments, the process 800 may obtain at least one of motion data or location data of the wireless device (block 810). For example, the motion data may include details about the speed of the wireless device (for example, the rate of movement), the movement path of the wireless device (for example, the direction), and changes in velocity over time (for example, the acceleration). Additionally, the location data may provide information about the geographic position of the wireless device, as well as the distance between the wireless device and a network device, such as the network device or one of the plurality of neighboring network devices.

In still yet more embodiments, the process 800 may generate a list of one or more neighboring network devices (block 820). The process 800 may generate the list of one or more neighboring network devices based on the obtained at least one of the motion data or the location data of the wireless device. In an example, the generated list may be ordered by priority, with neighboring network devices that are more likely to provide optimal connectivity placed higher on the list and neighboring network devices that are less likely to provide optimal connectivity placed lower on the list. The list may be ordered based on factors such as roaming probability, signal strength, or likelihood of coverage, ensuring that the wireless device can quickly and efficiently connect to the most optimal neighboring network device.

In many further embodiments, the process 800 may transmit, for roaming assistance, the list of one or more neighboring network devices to the wireless device unsolicited (block 830). In one or more embodiments, the process 800 may proactively transmit the list of one or more neighboring network devices to the wireless device for roaming assistance without receiving any request from the wireless device. For example, if the network device detects that the wireless device is nearing the edge of its coverage area, the network device may send the list of one or more neighboring network devices to the wireless device to assist the wireless device in preparing for an efficient handoff to the next network device.

In still yet further embodiments, the process 800 may receive a feedback on the roaming assistance (block 840). The process 800 may receive the feedback on the roaming assistance from the wireless device. In an example, the process 800 may receive the feedback in case of a roaming failure. In another example, the process 800 may receive the feedback in case of a successful, but suboptimal roam. By receiving feedback from the wireless device, the process 800 may improve roaming support, enhancing the accuracy and efficiency of future handoffs.

Although a specific embodiment for receiving a feedback on roaming assistance from a wireless device suitable for carrying out the various steps, processes, methods, and operations described herein is discussed with respect to FIG. 8, any of a variety of systems and/or processes may be utilized in accordance with embodiments of the disclosure. For example, the process 800 may receive a roaming assistance request from the wireless device. Additionally, the elements depicted in FIG. 8 may also be interchangeable with other elements of FIGS. 1-7 and FIGS. 9-12 as required to realize a particularly desired embodiment.

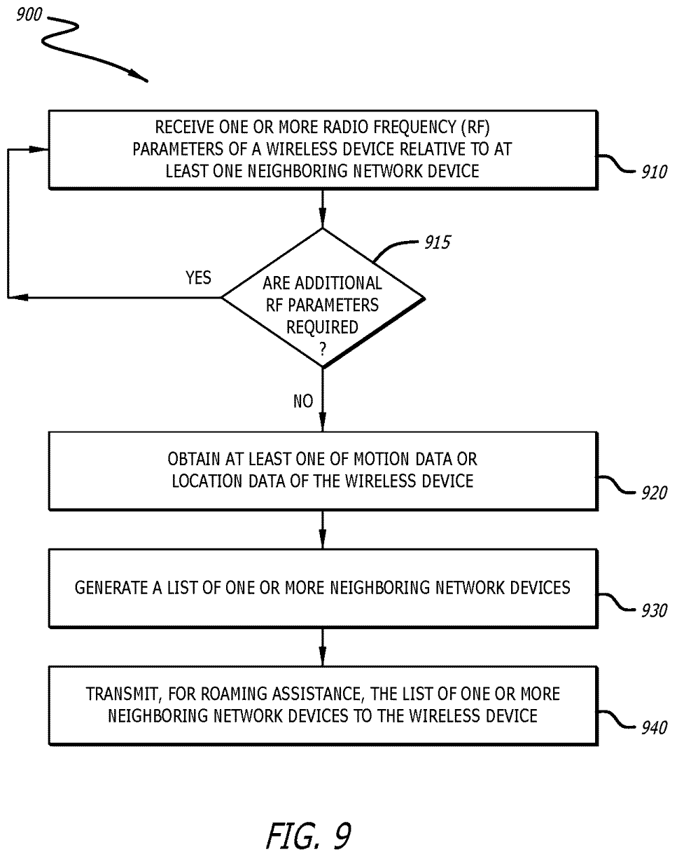

Referring to FIG. 9, a flowchart depicting a process 900 for obtaining at least one of motion data or location data of the wireless device based on one or more RF parameters in accordance with various embodiments of the disclosure is shown. In many embodiments, the process 900 may be implemented in a network device. For example, the network device may be an access point.

In several embodiments, the process 900 may receive one or more RF parameters of a wireless device relative to at least one neighboring network device (block 910). In an example, the one or more RF parameters may include RSSI. In another example, the one or more RF parameters may include SNR. The one or more RF parameters may be utilized to estimate the location and/or movement of the wireless device, including its direction, speed, or distance from the at least one neighboring network device, without the need for explicit location sharing by the wireless device.

In yet several embodiments, it is determined whether additional RF parameters are required (block 915). In one or more embodiments, additional RF parameters may be required when the process 900 is unable to estimate the location and/or movement of the wireless device based on the received RF parameters. If it is determined that additional RF parameters are required, in several additional embodiments, the process 900 may continue to receive one or more RF parameters of a wireless device relative to at least one neighboring network device (for example, from other neighboring network devices) (block 910). If it is determined that additional RF parameters are not required, in numerous other embodiments, the process 900 may obtain at least one of motion data or location data of the wireless device (block 920). For example, the motion data may include details about the speed of the wireless device (for example, the rate of movement), the movement path of the wireless device (for example, the direction), and changes in velocity over time (for example, the acceleration). Additionally, the location data may provide information about the geographic position of the wireless device, as well as the distance between the wireless device and a network device, such as the network device or one of the plurality of neighboring network devices.

In additional embodiments, the process 900 may generate a list of one or more neighboring network devices (block 930). The process 900 may generate the list of one or more neighboring network devices based on the obtained at least one of the motion data or the location data of the wireless device. In an example, the generated list may be ordered by priority, with neighboring network devices that are more likely to provide optimal connectivity placed higher on the list and neighboring network devices that are less likely to provide optimal connectivity placed lower on the list. The list may be ordered based on factors such as roaming probability, signal strength, or likelihood of coverage, ensuring that the wireless device can quickly and efficiently connect to the most optimal neighboring network device.

In still additional embodiments, the process 900 may transmit, for roaming assistance, the list of one or more neighboring network devices to the wireless device (block 940). For example, the process 700 may transmit the list of one or more neighboring network devices to the wireless device in a BTM message. In another example, the process 700 may transmit the list of one or more neighboring network devices to the wireless device in a neighbor report.

Although a specific embodiment for obtaining at least one of motion data or location data of the wireless devicer based on one or more RF parameters suitable for carrying out the various steps, processes, methods, and operations described herein is discussed with respect to FIG. 9, any of a variety of systems and/or processes may be utilized in accordance with embodiments of the disclosure. For example, the process 900 may receive a roaming assistance request from the wireless device and the process 900 may transmit the list of one or more neighboring network devices to the wireless device in response to receiving the roaming assistance request. Additionally, the elements depicted in FIG. 9 may also be interchangeable with other elements of FIGS. 1-8 and FIGS. 10-12 as required to realize a particularly desired embodiment.

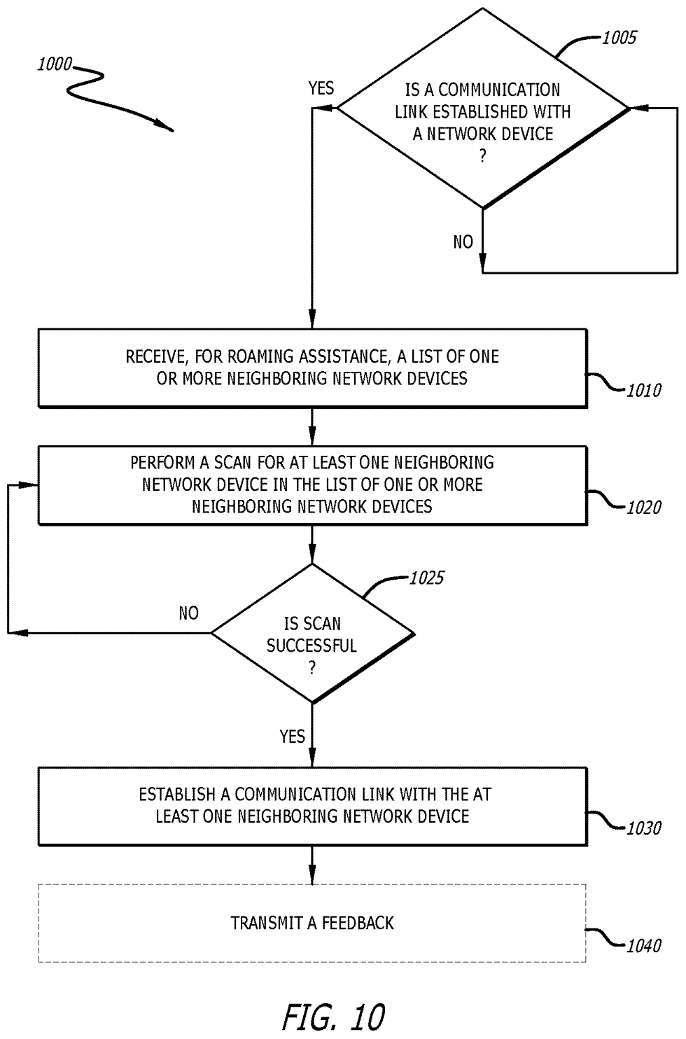

Referring to FIG. 10, a flowchart depicting a process 1000 for establishing a communication link with at least one neighboring network device in accordance with various embodiments of the disclosure is shown. In many embodiments, the process 1000 may be implemented in a wireless device. For example, the wireless device may be a station.

In a number of embodiments, it is determined if a communication link is established with a network device (block 1005). In one or more embodiments, the process 1000 may determine whether the communication link has been established with the network device based on performing an action such as verifying an exchange of a handshake or confirmation signal between the wireless device and the network device. In an example, if the exchange of the handshake is confirmed, then the process 1000 may determine that the communication link has been established with the network device. In another example, if the exchange of the handshake is not confirmed, then the process 1000 may determine that the communication link has not been established with the network device.

If it is determined that a communication link is not established with the network device, in a variety of embodiments, the process 1000 may continue to determine if a communication link is established with the network device (block 1005). If it is determined that the communication link is established with the network device, in further embodiments, the process 1000 may receive, for roaming assistance, a list of one or more neighboring network devices (block 1010). The process 1000 may receive the list of one or more neighboring network devices from the network device. In an example, the received list may be ordered by priority, with neighboring network devices that are more likely to provide optimal connectivity placed higher on the list and neighboring network devices that are less likely to provide optimal connectivity placed lower on the list. The list may be ordered based on factors such as roaming probability, signal strength, or likelihood of coverage, ensuring that the wireless device can quickly and efficiently connect to the most optimal neighboring network device.

In still further embodiments, the process 1000 may perform a scan for at least one neighboring network device in the list of one or more neighboring network devices (block 1020). For example, the process 1000 may perform a scan to detect at least one neighboring network device from the list of neighboring network devices. For example, the process 1000 may prioritize scanning a neighboring network device which may be ranked higher in the list, while excluding the neighboring network device which appears lower in the list.

In more embodiments, the process 1000 may determine if the scan is successful (block 1025). In an example, the scan may be considered successful if the wireless device can identify at least one neighboring network device from the list that meets the necessary criteria, such as signal strength, roaming probability, or other performance metrics. This includes evaluating factors such as the RSSI, which measures the signal strength between the wireless device and the neighboring network devices. Additionally, the wireless device may assess the roaming probability, which indicates the likelihood that the wireless device will transition to a specific neighboring network device, assisting to prioritize the most optimal neighboring network device.

If it is determined scan is not successful, in still more embodiments, the process 1000 may continue to perform the scan for the at least one neighboring network device in the list of one or more neighboring network devices (block 1020). If it is determined that the scan is successful, in additional embodiments, the process 1000 may establish a communication link with the at least one neighboring network device (block 1030). In an example, establishing the communication link may involve exchanging necessary authentication and association information between the wireless device and the most optimal neighboring network device, enabling the wireless device to maintain a continuous and stable connection as it transitions from one network device to another.

In additional embodiments, the process 1000 may transmit a feedback (block 1040). The process 1000 may transmit the feedback to one of the previously associated network device or to the at least one neighboring network device to which the wireless device is now associated. In an example, the process 1000 may transmit the feedback in case of a roaming failure. In another example, the process 1000 may transmit the feedback in case of a successful, but suboptimal roam. In one or more embodiments, transmitting the feedback may be optional.

Although a specific embodiment for establishing a communication link with the at least one neighboring network device suitable for carrying out the various steps, processes, methods, and operations described herein is discussed with respect to FIG. 10, any of a variety of systems and/or processes may be utilized in accordance with embodiments of the disclosure. For example, the process 1000 may transmit the roaming assistance request to the network device. Additionally, the elements depicted in FIG. 10 may also be interchangeable with other elements of FIGS. 1-9 and FIGS. 11-12 as required to realize a particularly desired embodiment.

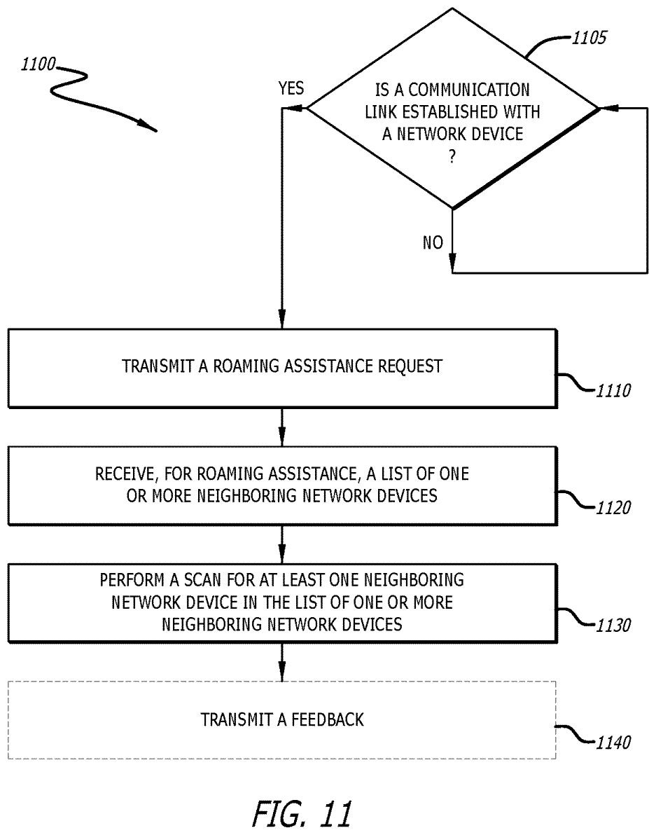

Referring to FIG. 11, a flowchart depicting a process 1100 for transmitting a feedback to a network device in accordance with various embodiments of the disclosure is shown. In many embodiments, the process 1100 may be implemented in a wireless device. For example, the wireless device may be a station.

In several embodiments, it is determined if a communication link is established with a network device (block 1105). In one or more embodiments, the process 1100 may determine whether the communication link has been established with the network device based on performing an action such as verifying an exchange of a handshake or confirmation signal between the wireless device and the network device. In an example, if the exchange of the handshake is confirmed, then the process 1100 may determine that the communication link has been established with the network device. In another example, if the exchange of the handshake is not confirmed, then the process 1100 may determine that the communication link has not been established with the network device.

If it is determined that the communication link is not established with the network device, in yet several embodiments, the process 1100 may continue to determine if the communication link is established with the network device (block 1105). If it is determined that the communication link is established with the network device, in additional embodiments, the process 1100 may transmit a roaming assistance request (block 1110). The process 1100 may transmit the roaming assistance request to the network device. The roaming assistance request may include an indication of at least one of a set of movement characteristics or a set of location characteristics of the wireless device. In an example, the indication may include a flag indicative of one of a moving state or a stationary state of the wireless device. In another example, the indication may include a geographical location of the wireless device. In yet another example, the indication may include a distance between the network device and the wireless device. In some examples, the indication may include a set of values representing one of a location of the wireless device or a movement of the wireless device. In an example, at least one value in the set of values may represent one of an acceleration of the wireless device, a direction of the wireless device, or a speed of the wireless device. Further, a value in the set of values may represent a vector including one or more of the acceleration of the wireless device, the direction of the wireless device, or the speed of the wireless device.

In still additional embodiments, the process 1100 may receive, for roaming assistance, a list of one or more neighboring network devices (block 1120). The process 1100 may receive the list of one or more neighboring network devices from the network device. In an example, the received list may be ordered by priority, with neighboring network devices that are more likely to provide optimal connectivity placed higher on the list and neighboring network devices that are less likely to provide optimal connectivity placed lower on the list. The list may be ordered based on factors such as roaming probability, signal strength, or likelihood of coverage, ensuring that the wireless device can quickly and efficiently connect to the most optimal neighboring network device.

In numerous additional embodiments, the process 1100 may perform a scan for at least one neighboring network device in the list of one or more neighboring network devices (block 1130). For example, the process 1100 may perform a scan to detect at least one neighboring network device from the list of neighboring network devices. For example, the process 1100 may prioritize scanning a neighboring network device which may be ranked higher in the list, while excluding the neighboring network device which appears lower in the list.

In numerous embodiments, the process 1100 may transmit a feedback (block 1140). The process 1000 may transmit the feedback to one of the previously associated network device or to the at least one neighboring network device to which the wireless device is now associated. In an example, the process 1000 may transmit the feedback in case of a roaming failure. In another example, the process 1000 may transmit the feedback in case of a successful, but suboptimal roam. In one or more embodiments, transmitting the feedback may be optional.

Although a specific embodiment for transmitting a feedback to network device suitable for carrying out the various steps, processes, methods, and operations described herein is discussed with respect to FIG. 11, any of a variety of systems and/or processes may be utilized in accordance with embodiments of the disclosure. For example, the process 1100 may receive the list of the one or more neighboring network devices unsolicited. Additionally, the elements depicted in FIG. 11 may also be interchangeable with other elements of FIGS. 1-10 and FIG. 12 as required to realize a particularly desired embodiment.

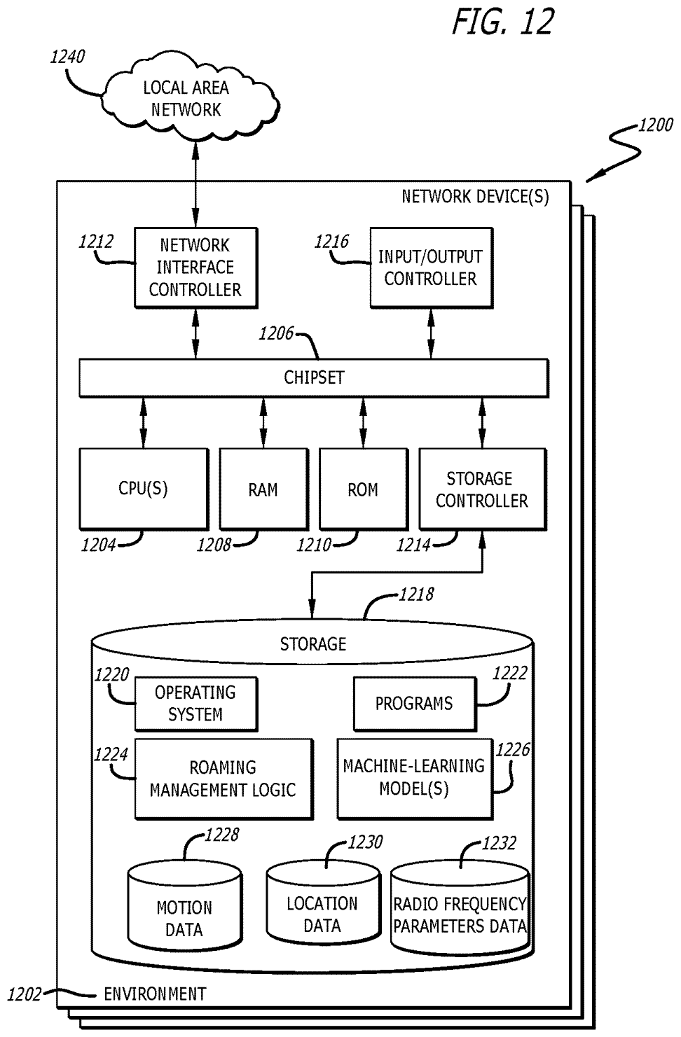

Referring to FIG. 12, a conceptual block diagram of a device 1200 suitable for configuration with a roaming management logic in accordance with various embodiments of the disclosure is shown. The embodiment of the conceptual block diagram depicted in FIG. 12 can illustrate a conventional server, switch, wireless LAN controller, AP, computer, workstation, desktop computer, laptop, tablet, network appliance, e-reader, smartphone, or other computing device, an ethernet interface, and can be utilized to execute any of the application and/or logic components presented herein. The embodiment of the conceptual block diagram depicted in FIG. 12 can also illustrate an AP, a switch, an edge node, an ethernet interface, or a router in accordance with various embodiments of the disclosure. The device 1200 may, in many non-limiting examples, correspond to physical devices or virtual resources described herein.

In many embodiments, the device 1200 may include an environment 1202 such as a baseboard or “motherboard,” in physical embodiments that can be configured as a printed circuit board with a multitude of components or devices connected by way of a system bus or other electrical communication paths. Conceptually, in virtualized embodiments, the environment 1202 may be a virtual environment that encompasses and executes the remaining components and resources of the device 1200. In more embodiments, one or more processors 1204, such as, but not limited to, central processing units (“CPUs”) can be configured to operate in conjunction with a chipset 1206. The processor(s) 1204 can be standard programmable CPUs that perform arithmetic and logical operations necessary for the operation of the device 1200. In a number of embodiments, the processor(s) 1204 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1206 may provide an interface between the processor(s) 1204 and the remainder of the components and devices within the environment 1202. The chipset 1206 can provide an interface to a random-access memory (“RAM”) 1208, which can be used as the main memory in the device 1200 in some embodiments. The chipset 1206 can further be configured to provide an interface to a computer-readable storage medium such as a read-only memory (“ROM”) 1210 or non-volatile RAM (“NVRAM”) for storing basic routines that can help with various tasks such as, but not limited to, starting up the device 1200 and/or transferring information between the various components and devices. The ROM 1210 or NVRAM can also store other application components necessary for the operation of the device 1200 in accordance with various embodiments described herein.

Additional embodiments of the device 1200 can be configured to operate in a networked environment using logical connections to remote computing devices and computer systems through a network, such as the network 1240. The chipset 1206 can include functionality for providing network connectivity through a network interface card (“NIC”) 1212, which may comprise a gigabit Ethernet adapter or similar component. The NIC 1212 can be capable of connecting the device 1200 to other devices over the network 1240. It is contemplated that multiple NICs 1212 may be present in the device 1200, connecting the device to other types of networks and remote systems.

In further embodiments, the device 1200 can be connected to a storage 1218 that provides non-volatile storage for data accessible by the device 1200. The storage 1218 can, for instance, store an operating system 1220 and programs 1222 (e.g., applications). The storage 1218 can be connected to the environment 1202 through a storage controller 1214 connected to the chipset 1206. In various other embodiments, the storage 1218 can consist of one or more physical storage units. The storage controller 1214 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1200 can store data within the storage 1218 by transforming the physical state of the physical storage units to reflect the information being stored. The specific transformation of physical state can depend on various factors. Examples of such factors can include, but are not limited to, the technology used to implement the physical storage units, whether the storage 1218 is characterized as primary or secondary storage, and the like.

In many more embodiments, the device 1200 can store information within the storage 1218 by issuing instructions through the storage controller 1214 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1200 can further read or access information from the storage 1218 by detecting the physical states or characteristics of one or more particular locations within the physical storage units.

In addition to the storage 1218 described above, the device 1200 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1200. In some examples, the operations performed by a cloud computing network, and/or any components included therein, may be supported by one or more devices similar to device 1200. Stated otherwise, some or all of the operations performed by the cloud computing network, and or any components included therein, may be performed by one or more devices 1200 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1218 can store an operating system 1220 utilized to control the operation of the device 1200. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1218 can store other system or application programs and data utilized by the device 1200.

In many additional embodiments, the storage 1218 or other computer-readable storage media is encoded with computer-executable instructions which, when loaded into the device 1200, may transform it from a general-purpose computing system into a special-purpose computer capable of implementing the embodiments described herein. These computer-executable instructions may be stored as programs 1222 (e.g., an application) and transform the device 1200 by specifying how the processor(s) 1204 can transition between states, as described above. In some embodiments, the device 1200 has access to computer-readable storage media storing computer-executable instructions which, when executed by the device 1200, perform the various processes described above with regard to FIGS. 1-11. In certain embodiments, the device 1200 can also include computer-readable storage media having instructions stored thereupon for performing any of the other computer-implemented operations described herein.

In many further embodiments, the device 1200 may include a roaming management logic 1224. The roaming management logic 1224 can be configured to perform one or more of the various steps, processes, operations, and/or other methods that are described above. The roaming management logic 1224 can be a set of instructions stored within a non-volatile memory that, when executed by the processor(s) 1204 can carry out these steps, etc. In some embodiments, the roaming management logic 1224 may be a client application that resides on a network-connected device, such as, but not limited to, a server, switch, an ethernet interface, personal or mobile computing device in a single or distributed arrangement.

In numerous embodiments, when the device 1200 is configured as a network device (as described in the foregoing description of FIGS. 4 and 5), the roaming management logic 1224 may be configured to establish a communication link with a wireless device, obtain at least one of motion data or location data of the wireless device, generate a list of one or more neighboring network devices based on the obtained at least one of the motion data or the location data of the wireless device, and transmit, for roaming assistance, the list of one or more neighboring network devices to the wireless device.

In numerous more embodiments, when the device 1200 is configured as a wireless device (as described in the foregoing description of FIGS. 4 and 5), the roaming management logic 1224 may be configured to establish a communication link with a network device, receive, for roaming assistance, a list of one or more neighboring network devices, where the list of one or more neighboring network devices is based on at least one of motion data or location data of the wireless device, and perform a scan for at least one neighboring network device in the list of one or more neighboring network devices.

In some embodiments, the storage 1218 can include motion data 1228. The motion data 1228 may refer to the speed of the wireless device (for example, the rate of movement), the movement path of the wireless device (for example, the direction), and changes in velocity over time (for example, acceleration). The network device may utilize the motion data 1228 to provide customized information to the wireless device regarding the next optimal network device (also referred to as the neighboring network device), thereby reducing the need for the wireless device to perform scanning operations at the edge of a BSA or cell. For example, by analyzing the motion data of 1228, the network device can assess the likelihood that each neighboring network device is within the range or movement path of the wireless device. By providing this predictive information to the wireless device, the network device may assist the wireless device in establishing a connection with the most optimal neighboring network device, thus minimizing the need for the wireless device to perform extensive scanning across multiple channels or neighboring network devices.

In various embodiments, the storage 1218 can include location data 1230. The location data 1230 may refer to data about the geographic position of the wireless device, as well as the distance between the wireless device and the network device or between the wireless device and one or more neighboring network devices. The network device may utilize the location data 1230 to provide customized information to the wireless device regarding the next optimal network device, thereby reducing the need for the wireless device to perform scanning operations at the edge of the BSA or the cell. For example, by analyzing the location data 1230, the network device may determine which neighboring network devices are likely within range. This enables the network device to provide the wireless device with tailored information regarding the most suitable neighboring network device to connect to next.

In a number of embodiments, the storage 1218 can include Radio Frequency (RF) parameters data 1232. The RF parameters data 1232 may include data of one or more RF parameters of the wireless device relative to at least one neighboring network device. In an example, the one or more RF parameters may include a Received Signal Strength Indicator (RSSI). The network device may utilize the RF parameters data 1232 to provide the wireless device with information about the next optimal network device to which it may connect. For example, if the RSSI from a neighboring network device is above a threshold value, the network device may determine that the neighboring network device is the most optimal candidate for connection. The network device may then provide this information to the wireless device, enabling the wireless device to connect to the optimal neighboring network device without unnecessary scanning or disconnection delays.

In still further embodiments, the device 1200 can also include one or more input/output controllers 1216 for receiving and processing input from a number of input devices, such as a keyboard, a mouse, a touchpad, a touch screen, an electronic stylus, or other type of input device. Similarly, an input/output controller 1216 can be configured to provide output to a display, such as a computer monitor, a flat panel display, a digital projector, a printer, or other type of output device. Those skilled in the art will recognize that the device 1200 might not include all of the components shown in FIG. 12 and can include other components that are not explicitly shown in FIG. 12 or might utilize an architecture completely different than that shown in FIG. 12.

As described above, the device 1200 may support a virtualization layer, such as one or more virtual resources executing on the device 1200. In some examples, the virtualization layer may be supported by a hypervisor that provides one or more virtual machines running on the device 1200 to perform functions described herein. The virtualization layer may generally support a virtual resource that performs at least a portion of the techniques described herein.

Finally, in numerous additional embodiments, data may be processed into a format usable by a ML model 1226 (e.g., feature vectors), and/or other pre-processing techniques. The ML model 1226 may be any type of ML model, such as supervised models, reinforcement models, and/or unsupervised models. The ML model 1226 may include one or more of linear regression models, logistic regression models, decision trees, Naïve Bayes models, neural networks, k-means cluster models, random forest models, and/or other types of ML models 1226. In an example, the ML model 1226 may include the plurality of classifiers, each trained for a specific task such as error correction and encoding or decoding of one or more data frames transmitted before and after power transitioning phase by the device, that share common encoder(s).

The ML model(s) 1226 can be configured to generate inferences to make predictions or draw conclusions from data. An inference can be considered the output of a process of applying a model to new data. This can occur by learning from at least the motion data 1228, the location data 1230, and the RF parameters data 1232. These predictions are based on patterns and relationships discovered within the data. To generate an inference, the trained model can take input data and produce a classification result. The input data can be in various forms, such as images, audio, text, or numerical data, network packet data depending on the type of problem the model was trained to solve. The output of the model can also vary depending on the problem, and can be a single number, a probability distribution, a set of labels, a decision about an action to take, etc. Ground truth for the ML model(s) 1226 may be generated by human/administrator verifications or may compare predicted outcomes with actual outcomes. Further, the ML model(s) 1226 may be utilized to select the next optimal neighboring network device by utilizing one or more of the motion data 1228, the location data 1230, or the RF parameters data 1232.

Although a specific embodiment for a device suitable for configuration with the roaming management logic for carrying out the various steps, processes, methods, and operations described herein is discussed with respect to FIG. 12, any of a variety of systems and/or processes may be utilized in accordance with embodiments of the disclosure. For example, the device 1200 may be in a virtual environment such as a cloud-based network administration suite, or it may be distributed across a variety of network devices or APs. The elements depicted in FIG. 12 may also be interchangeable with other elements of FIGS. 1-11 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or different computing devices) in order to achieve similar results in a manner that is more appropriate to the requirements of a specific application. It is therefore to be understood that the present disclosure can be practiced other than specifically described without departing from the scope of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the scope of the present disclosure, as set forth in the appended claims, as might be apparent to those of ordinary skill in the art, are also encompassed by the present disclosure.

What is claimed is:

1. A network device, comprising:
one or more processors; and
a memory communicatively coupled to the one or more processors, wherein the memory comprises a roaming management logic that is configured to:
establish a communication link with a wireless device;
obtain at least one of motion data or location data of the wireless device;
generate a list of one or more neighboring network devices based on the obtained at least one of the motion data or the location data of the wireless device; and
transmit, for roaming assistance, the list of one or more neighboring network devices to the wireless device.

2. The network device of claim 1, wherein the roaming management logic is further configured to:
receive a roaming assistance request from the wireless device, comprising an indication of at least one of a set of movement characteristics or a set of location characteristics of the wireless device; and
obtain at least one of the motion data or the location data of the wireless device based on the indication of at least one of the set of movement characteristics or the set of location characteristics of the wireless device.

3. The network device of claim 2, wherein the roaming assistance request is received in at least one of an action frame or a wireless frame.

4. The network device of claim 3, wherein the wireless frame is one of an Advanced Service Request (ASR) or a Service Classification Signal (SCS).

5. The network device of claim 2, wherein the roaming assistance request is configured to indicate at least one traffic type that the wireless device is to transmit.

6. The network device of claim 2, wherein the indication comprises a flag indicative of one of a moving state or a stationary state of the wireless device.

7. The network device of claim 2, wherein the indication comprises a geographical location of the wireless device.

8. The network device of claim 2, wherein the indication comprises a distance between the network device and the wireless device.

9. The network device of claim 2, wherein the indication comprises a set of values representing one of a location of the wireless device or a movement of the wireless device.

10. The network device of claim 9, wherein at least one value in the set of values represents one of: an acceleration of the wireless device, a direction of the wireless device, or a speed of the wireless device.

11. The network device of claim 9, wherein a value in the set of values represents a vector comprising one or more of: an acceleration of the wireless device, a direction of the wireless device, or a speed of the wireless device.

12. The network device of claim 1, wherein the roaming management logic is further configured to obtain at least one of the motion data or the location data of the wireless device based on one or more Radio Frequency (RF) parameters of the wireless device relative to at least one neighboring network device.

13. The network device of claim 12, wherein the one or more RF parameters comprise a Received Signal Strength Indicator (RSSI).

14. The network device of claim 1, wherein the roaming management logic is further configured to transmit the list of one or more neighboring network devices to the wireless device in one of a basic service set (BSS) transition management (BTM) message or a neighbor report.

15. The network device of claim 1, wherein the roaming management logic is further configured to transmit the list of one or more neighboring network devices to the wireless device unsolicited.

16. The network device of claim 1, wherein the roaming management logic is further configured to transmit, to the wireless device, a roaming probability indication for at least one neighboring network device in the list of one or more neighboring network devices.

17. The network device of claim 1, wherein the roaming management logic is further configured to transmit, to the wireless device, a signal strength indicator corresponding to a mid-point between the network device and a neighboring network device in the list of one or more neighboring network devices.

18. The network device of claim 1, wherein the roaming management logic is further configured to receive, from the wireless device, feedback on the roaming assistance in response to the transmission of the list of one or more neighboring network devices.

19. A wireless device, comprising:
one or more processors; and
a memory communicatively coupled to the processor, wherein the memory comprises a roaming management logic that is configured to:
establish a communication link with a network device;
receive, for roaming assistance, a list of one or more neighboring network devices, wherein the list of one or more neighboring network devices is based on at least one of motion data or location data of the wireless device; and
perform a scan for at least one neighboring network device in the list of one or more neighboring network devices.

20. A method for managing roaming in a wireless network, the method comprising:
establishing a communication link with a wireless device;
obtaining at least one of motion data or location data of the wireless device;
generating a list of one or more neighboring network devices based on the obtained at least one of the motion data or the location data of the wireless device; and
transmitting, for roaming assistance, the list of one or more neighboring network devices to the wireless device.
